(19) United States
(12) Patent Application Publication
(10) Pub. No.: US 2003/0052919 A1
(43) Pub. Date: Mar. 20, 2003

(54) Animated state machine

(76) Inventors: Martin Paul Tlaskal, Elizabeth Bay (AU); David Geoffrey Slack-Smith, Marsfield (AU); Alexander Will, Eastwood (AU)

Correspondence Address: FITZPATRICK CELLA HARPER & SCINTO, 30 ROCKEFELLER PLAZA, NEW YORK, NY, 10112, US

(21) Appl. No.: 10/234,366

(22) Filed: Sep. 5, 2002

(30) Foreign Application Priority Data
Sep. 6, 2001 (AU) PR7535
Feb. 27, 2002 (AU) PS0790

(51) Int. Cl. G09G 5/00

(52) U.S. Cl. 345/764

(57) ABSTRACT

A method of updating a route currently being executed by an animated state machine is disclosed. The animated state machine is associated with a graphical object and comprises a plurality of states each of which corresponds to a mode of rendering the graphical object. Each of the states has an associated state transition representing a transition of the graphical object between the states. The route comprises a first sequential plurality of the state transitions. The method removes any previously executed state transitions from the currently executing route and selects a second sequential plurality of remaining state transitions to represent a new route between a current state of the graphical object and a destination state. If a second state transition of the new route is equal to a state of a currently executing transition of the currently executing route, then the currently executing transition is reversed and a first transition of the new route is removed from the new route to produce an amended new route which is utilised to update the currently executing route. Otherwise, the new route is utilised to update the currently executing route.

### TECHNICAL FIELD OF THE INVENTION

The present invention relates generally to computer programming and, in particular, to the processing of asynchronous events by an application program. The present invention relates to a method and apparatus for processing asynchronous events. The invention also relates to a computer program product including a computer readable medium having recorded thereon a computer program for processing asynchronous events.

### BACKGROUND ART

Before proceeding with a description of the background art, a brief review of terminology to be used throughout the following description is appropriate.

In an object oriented programming environment, such as Visual C⁺⁺, the term “object” is used to refer to a computer software component comprising data structures, and procedures (often referred to as methods) for manipulating the data structures. Objects can communicate with one another by sending messages using some form of communications protocol. A protocol is a table which is associated with an object and which is used to map protocol side identifiers to sets of message identifiers. The message identifiers are associated with the messages sent between objects. The side identifiers identify which side of a protocol a particular object relates. For example, an object may use the “sender” side of a particular protocol for an instance associated with the object, and the object may be related to another object which uses the “receiver” side of the same protocol. Each protocol side identifier maps to a set of message identifiers corresponding to messages that an object implementing that side of the protocol may transmit.

The procedures of a particular object can be activated by a message sent from another object, where the interior structure of each object is entirely hidden from any other object (a property referred to as encapsulation). Each object can have one or more associated interfaces which specify the communication between two objects. For example, each object has its own private variables and if a procedure contained within a specific object does not refer to non-local variables then the interface of the object is defined by a parameter list contained within the object. Variables of an object store information but do not define how that information is processed.

Objects are derived from a template or type of object, and the collection of objects that are instances of a particular template are said to form a class. A class definition defines the attributes (ie. properties) of the objects within a particular class. Generally the objects within a class are ordered in a hierarchical manner such that an object has a parent object (ie. super-class) at the next higher level in the hierarchy and one or more child objects (ie. sub-class) at the next lower level. An object is generally mapped to a parent object or a child object by means of a mapping table, often referred to as a sibling table, which is associated with the object.

Attributes can be local to an object, or can be inherited from the parent object. Inheritance is the term given to the manner in which characteristics of objects can be replicated and instantiated in other objects. Attributes of an object can also be inherited from a child object often without limit on the number of inheritances. The object from which all of the objects within the class are derived is referred to as the base class object.

Inheritance is both static by abstract data type and dynamic by instantiation and value. Inheritance rules define that which can be inherited and inheritance links define the parent and child of inheritance attributes.

Generally, an object has a permanent connection with a parent application program. However, some objects (eg. embedded objects) have no permanent connection with a parent application. In this case, when the object is activated the parent application is generally launched. For example, a button object on a graphical user interface system, when activated, might cause a certain application program to execute in order to perform some function.

Many conventional computer graphical user interface systems, such as the Windows™ graphical user interface system, utilise objects to process asynchronous events such as a mouse click or a key-board press. These asynchronous events are most often generated by a peripheral device and as such, asynchronous events are generally referred to as external events. External events are generally processed by a graphical user interface system using one or more objects which are called by an application program. Some external events may require several different actions (eg. activating a procedure, calculating a data value, determining the meaning of a key-board press, or the like) to be performed by an application program and as such, many application programs use a certain class of object called an event handler object to process external events. Each external event can be handled by a different event handler object which itself often generates internal events within an application program, and thus event handler objects are generally configured to communicate with one another. However, a certain type of external event (eg. a mouse click) is generally handled by a certain instance of event handler object (eg. a mouse event handler object).

Event handler objects communicate with one another by sending messages, as described above, using some form of communications protocol.

During the development of a graphical user interface, knowledge from at least two professional disciplines is generally needed. On the one hand, graphical user interface designers, usability experts and/or artists, determine how the graphical user interface will “look-and-feel”, where a graphical user interface generally comprises a number of screens (ie. one or more graphical objects rendered on a display device). On the other hand, computer programmers create software that will allow the graphical user interface to operate, change appearance, pass any user interaction messages to software applications, and present feedback from the software application to the user.

One of the difficulties that often arises from the separation of graphical user interface development roles is that although a designer may have a clear idea of how the graphical user interface should look and function, it is the programmers who actually determine how the graphical user interface functions. This results in a high degree of interdependence between professional disciplines during the development of a graphical user interface.

The interdependence between professional disciplines as described above can be alleviated somewhat through the use of finite state machines. Finite state machines are commonly used to model graphical objects. Modelling graphical objects using finite state machines enables the separation of the graphical user interface associated with an object from the implementation of that object. Finite state machines provide a simple automation method where an input data string is read once from left to right looking at each symbol in turn. At any one time the finite state machine is in one of many internal states and the state changes after each symbol is read with the new state depending on the symbol just read and on the source state.

A finite state machine is determined by a state transition function ƒ as follows

ƒ: I×Q→Q

where I is the set of possible input symbols, Q is the set of states, and I×Q is the Cartesian product of I and Q. The function ƒ is generally represented either by a state transition table or by a state transition diagram.

Finite state machines can be used to model discrete controls which are commonly used on graphical user interfaces and which a user interacts with to drive a particular graphical user interface. Interacting with a control often results in a change to the visual appearance of any graphical objects associated with the control. For example, a button represented on a graphical user interface using one or more graphical objects can be configured to glow when a mouse cursor moves over the button as well as to provide feedback when the button is selected by using a mouse in a conventional manner. More complicated controls such as list boxes can have a larger number of possible visual appearances.

Most conventional graphical user interface controls exhibit instantaneous changes in visual appearance. That is, as soon as a user interaction occurs (eg. a mouse click), the control is immediately re-rendered to show a changed visual appearance. Unfortunately, the differences between the visual appearance before and after the user interaction is often significant. Thus, even when modelled using a finite state machine, the instantaneous change of visual appearance in a control often appears abrupt and unattractive. In addition, the modelling of a graphical user interface control by a finite state machine inherently limits the control to a finite number of resting states (ie. semi permanent states).

### SUMMARY OF THE INVENTION

It is an object of the present invention to substantially overcome, or at least ameliorate, one or more disadvantages of existing arrangements.

According to one aspect of the present invention there is provided a method of rendering a graphical object on a graphical user interface, said graphical object having an associated animated state machine, said animated state machine comprising a plurality of states each of which corresponds to a mode of rendering said graphical object, each of said states having an associated state transition representing a transition of said graphical object between at least two of said states, said method comprising at least the step of:

executing at least one state transition between a first state of said graphical object and a second state, in order to render said graphical object according to attribute values defined for said graphical object at one or more corresponding times between said first state and said second state,

wherein in response to an event occurring in relation to said graphical user interface at any time prior to completion of said execution, said execution of said at least one state transition is altered in order to render said graphical object according to a third state.

According to another aspect of the present invention there is provided an apparatus for rendering a graphical object on a graphical user interface, said graphical object having an associated animated state machine, said animated state machine comprising a plurality of states each of which corresponds to a mode of rendering said graphical object, each of said states having an associated state transition representing a transition of said graphical object between at least two of said states, said apparatus comprising:

execution means for executing at least one state transition between a first state of said graphical object and a second state, in order to render said graphical object according to attribute values defined for said graphical object at one or more corresponding times between said first state and said second state,

wherein in response to an event occurring in relation to said graphical user interface at any time prior to completion of said execution, said execution of said at least one state transition is altered in order to render said graphical object according to a third state.

According to still another aspect of the present invention there is provided a program including computer-implemented program codes, said program being configured for rendering a graphical object on a graphical user interface, said graphical object having an associated animated state machine, said animated state machine comprising a plurality of states each of which corresponds to a mode of rendering said graphical object, each of said states having an associated state transition representing a transition of said graphical object between at least two of said states, said program comprising:

code for executing at least one state transition between a first state of said graphical object and a second state, in order to render said graphical object according to attribute values defined for said graphical object at one or more corresponding times between said first state and said second state,

wherein in response to an event occurring in relation to said graphical user interface at any time prior to completion of said execution, said execution of said at least one state transition is altered in order to render said graphical object according to a third state.

According to still another aspect of the present invention there is provided a graphical user interface comprising one or more graphical objects, each of said graphical objects having one or more associated states, each of said states representing a mode of rendering a corresponding graphical object, said graphical user interface being characterised in that transitioning between a plurality of states associated with at least one of said graphical objects is executed by an animated state machine.

According to still another aspect of the present invention there is provided a method of updating a route currently being executed by an animated state machine, said animated state machine being associated with a graphical object and comprising a plurality of states each of which corresponds to a mode of rendering said graphical object, each of said states having an associated state transition representing a transition of said graphical object between at least two of said states, wherein said route comprises a first sequential plurality of said state transitions, said method comprising the steps of:

removing any unnecessary state transitions from said currently executing route; and

selecting a second sequential plurality of remaining state transitions to represent a new route between a first state of said graphical object and a second state, wherein,

if at least one state of said new route is equal to a first state of a currently executing transition of said currently executing route, then said currently executing transition is reversed and a first transition of said new route is removed from said new route to produce an amended new route which is utilised to update said currently executing route, otherwise

said new route is utilised to update said currently executing route.

According to still another aspect of the present invention there is provided a method of updating a route currently being executed by an animated state machine, said animated state machine being associated with a graphical object and comprising a plurality of states each of which corresponds to a mode of rendering said graphical object, each of said states having an associated state transition representing a transition of said graphical object between said states, wherein said route comprises a first sequential plurality of said stare transitions, said method comprising the steps of:

removing any unnecessary state transitions from said currently executing route;

selecting a sequential plurality of any remaining state transitions to represent a new route between a first state of said graphical object and a second state;

updating said currently executing route utilising said new route.

According to still another aspect of the present invention there is provided a method of updating an animated state machine in response to a user event, said animated state machine being associated with a graphical object, said method comprising the steps of:

deleting any unnecessary transitions from a currently executing route of said animated state machine upon detection of said user event; and

selecting a sequential plurality of any remaining state transitions to form a new route representing a least number of state transitions required to render said graphical object according to a current state and a destination state,

wherein if a second state of said new route is equal to a first state of a currently executing transition of said currently executing route, then said currently executing transition is reversed and a first transition of said new route is removed from said new route to produce an amended new route which is utilised to update said currently executing route, otherwise

said new route is utilised to update said currently executing route.

According to still another aspect of the present invention there is provided an apparatus for updating a route currently being executed by an animated state machine, said animated state machine being associated with a graphical object and comprising a plurality of states each of which corresponds to a mode of rendering said graphical object, each of said states having an associated state transition representing a transition of said graphical object between at least two of said states, wherein said route comprises a first sequential plurality of said state transitions, said apparatus comprising:

removal means for removing any unnecessary state transitions from said currently executing route; and

selection means for selecting a second sequential plurality of remaining state transitions to represent a new route between a first state of said graphical object and a second state, wherein,

if at least one state of said new route is equal to a first state of a currently executing transition of said currently executing route, then said currently executing transition is reversed and a first transition of said new route is removed from said new route to produce an amended new route which is utilised to update said currently executing route, otherwise

said new route is utilised to update said currently executing route.

According to still another aspect of the present invention there is provided an apparatus for updating a route currently being executed by an animated state machine, said animated state machine being associated with a graphical object and comprising a plurality of states each of which corresponds to a mode of rendering said graphical object, each of said states having an associated state transition representing a transition of said graphical object between said states, wherein said route comprises a first sequential plurality of said state transitions, said apparatus comprises:

removal means for removing any unnecessary state transitions from said currently executing route;

selection means for selecting a sequential plurality of any remaining state transitions to represent a new route between a first state of said graphical object and a second state;

update means for updating said currently executing route utilising said new route.

According to still another aspect of the present invention there is provided an apparatus for updating an animated state machine in response to a user event, said animated state machine being associated with a graphical object, said apparatus comprising:

deletion means for deleting any unnecessary transitions from a currently executing route of said animated state machine upon detection of said user event; and

selection means for selecting a sequential plurality of any remaining state transitions to form a new route representing a least number of state transitions required to render said graphical object according to a current state and a destination state,

wherein if a second state of said new route is equal to a first state of a currently executing transition of said currently executing route, then said currently executing transition is reversed and a first transition of said new route is removed from said new route to produce an amended new route which is utilised to update said currently executing route, otherwise

said new route is utilised to update said currently executing route.

According to still another aspect of the present invention there is provided a program stored in a memory medium of an apparatus, said program being configured to update a route currently being executed by an animated state machine, said animated state machine being associated with a graphical object and comprising a plurality of states each of which corresponds to a mode of rendering said graphical object, each of said states having an associated state transition representing a transition of said graphical object between at least two of said states, wherein said route comprises a first sequential plurality of said state transitions, said program comprising:

code for removing any unnecessary state transitions from said currently executing route; and

code for selecting a second sequential plurality of remaining state transitions to represent a new route between a first state of said graphical object and a second state, wherein,

if at least one state of said new route is equal to a first state of a currently executing transition of said currently executing route, then said currently executing transition is reversed and a first transition of said new route is removed from said new route to produce an amended new route which is utilised to update said currently executing route, otherwise

said new route is utilised to update said currently executing route.

According to still another aspect of the present invention there is provided a program stored in a memory medium of an apparatus, said program being configured to update a route currently being executed by an animated state machine, said animated state machine being associated with a graphical object and comprising a plurality of states each of which corresponds to a mode of rendering said graphical object, each of said states having an associated state transition representing a transition of said graphical object between said states, wherein said route comprises a first sequential plurality of said state transitions, said program comprising:

code for removing any unnecessary state transitions from said currently executing route;

code for selecting a sequential plurality of any remaining state transitions to represent a new route between a first state of said graphical object and a second state;

code for updating said currently executing route utilising said new route.

According to still another aspect of the present invention there is provided a program including computer-implemented program codes, said program being configured to update an animated state machine in response to a user event, said animated state machine being associated with a graphical object, said program comprising:

code for deleting any unnecessary transitions from a currently executing route of said animated state machine upon detection of said user event; and

code for selecting a sequential plurality of any remaining state transitions to form a new route representing a least number of state transitions required to render said graphical object according to a current state and a destination state,

wherein if a second state of said new route is equal to a first state of a currently executing transition of said currently executing route, then said currently executing transition is reversed and a first transition of said new route is removed front said new route to produce an amended new route which is utilised to update said currently executing route, otherwise

said new route is utilised to update said currently executing route.

According to still another aspect of the present invention there is provided a method of updating a route currently being executed by an animated state machine, said animated state machine being associated with a graphical object and comprising a plurality of states each of which corresponds to a mode of rendering said graphical object, each of said states having an associated state transition representing a transition of said graphical object between at least two of said states, wherein said route comprises a first sequential plurality of said state transitions, said method comprising the steps of:

removing any previously executed state transitions from said currently executing route of said animated state machine; and

selecting a second sequential plurality of remaining state transitions to represent a new route between a current state of said graphical object and a destination state, said new route including at least one intermediate state wherein,

if a second state of said new route is equal to a first state of a currently executing transition of said currently executing route, then said currently executing transition is reversed and a first transition of said new route is removed from said new route to produce an amended new route which is utilised to update said currently executing route, otherwise

said new route is utilised to update said currently executing route.

According to still another aspect of the present invention there is provided an apparatus for updating a route currently being executed by an animated state machine, said animated state machine being associated with a graphical object and comprising a plurality of states each of which corresponds to a mode of rendering said graphical object, each of said states having an associated state transition representing a transition of said graphical object between at least two of said states, wherein said route comprises a first sequential plurality of said state transitions, said apparatus comprising:

removal means for removing any previously executed state transitions from said currently executing route of said animated state machine; and

selection means for selecting a second sequential plurality of remaining state transitions to represent a new route between a current state of said graphical object and a destination state, said new route including at least one intermediate state wherein,

if a second state of said new route is equal to a first state of a currently executing transition of said currently executing route, then said currently executing transition is reversed and a first transition of said new route is removed from said new route to produce an amended new route which is utilised to update said currently executing route, otherwise

said new route is utilised to update said currently executing route.

According to still another aspect of the present invention there is provided a program including computer-implemented program codes, said program being configured to update a route currently being executed by an animated state machine, said animated state machine being associated with a graphical object and comprising a plurality of states each of which corresponds to a node of rendering said graphical object, each of said states having an associated state transition representing a transition of said graphical object between at least two of said states, wherein said route comprises a first sequential plurality of said state transitions, said program comprising:

code for removing any previously executed state transitions from said currently executing route of said animated state machine; and

code for selecting a second sequential plurality of remaining state transitions to represent a new route between a current state of said graphical object and a destination state, said new route including at least one intermediate state wherein,

if a second state of said new route is equal to a first state of a currently executing transition of said currently executing route, then said currently executing transition is reversed and a first transition of said new route is removed from said new route to produce an amended new route which is utilised to update said currently executing route, otherwise

said new route is utilised to update said currently executing route.

Other aspects of the invention are also disclosed.

### BRIEF DESCRIPTION OF THE DRAWINGS

One or more embodiments of the present invention will now be described with reference to the drawings, in which:

FIG. 1 is a flow chart showing a method of determining a current route between a source state and a destination state for a particular control;

FIG. 2 is a flow chart showing a method of determining of determining a route to a new destination state for an animated state machine associated with a control of a graphical user interface;

FIG. 3 is a flow chart showing a method of adding a new transition object to the end of a currently animating route of an animated state machine;

FIG. 4 is a flow chart showing a method of updating the appearance of any graphical objects associated with the animated state machine of FIGS. 1 to 3;

FIG. 5 is a flow chart showing a method of updating the state of a graphical object during a transition;

FIG. 6 is a schematic block diagram of a general purpose computer upon which arrangements described can be practiced;

FIG. 7 shows a screen with four menu items, configured in accordance with an application program implemented using the methods of FIGS. 1 to 5 and FIGS. 14 to 24;

FIG. 8 shows another screen with four menu items, configured in accordance with the application program of FIG. 7;

FIG. 9 shows another screen with four menu items, configured in accordance with the application program of FIG. 7;

FIG. 10 shows another screen with four menu items, configured in accordance with the application program of FIG. 7;

FIG. 11 shows another screen with two menu items, configured in accordance with the application program of FIG. 7;

FIG. 12 shows another screen with six menu items, configured in accordance with the application program of FIG. 7;

FIG. 13 is a flow chart showing a process performed when a user presses the down arrow key on the keyboard of FIG. 6, if the screen of FIG. 7 is being displayed;

FIG. 14 is a flow diagram showing a method of connecting two event handler objects;

FIG. 15 is a flow diagram showing a method of disconnecting two event handler objects;

FIG. 16 is a flow diagram showing a method of sending a message from a first event handler object to a single specified event handler object;

FIG. 17 is a flow diagram showing a method of sending a message from a first event handler object to all event handler objects which are associated with an interface of the first event handler object;

FIG. 18 is a flow diagram showing a further method of sending a message from a first event handler object to all event handler objects which are associated with an interface of the first event handler object;

FIG. 19 is a flow diagram showing a still further method of sending a message from a first event handler object to all event handler objects which are associated with an interface of the first event handler object;

FIG. 20 is a flow diagram showing a method of receiving a message from an associated event handler object;

FIG. 21 is a flow diagram showing a further method of receiving a message from an associated event handler object;

FIG. 22 is a flow diagram showing a still further method of receiving a message from an associated event handler object;

FIG. 23 is a flow diagram showing a still further method of receiving a message from an associated event handler object; and

FIG. 24 is a flow chart showing a further method of determining a route to a new destination state for an animation state machine associated with a control of a graphical user interface.

### DETAILED DESCRIPTION INCLUDING BEST MODE

Where reference is made in any one or more of the accompanying drawings to step s and/or features, which have the same reference numerals, those step s and/or features have for the purposes of this description the same function(s) or operation(s), unless the contrary intention appears.

Some portions of the description which follows are explicitly or implicitly presented in terms of algorithms and symbolic representations of operations on data within a computer memory. These algorithmic descriptions and representations are the means used by those skilled in the data processing arts to most effectively convey the substance of their work to others skilled in the art. An algorithm is here, and generally, conceived to be a self-consistent sequence of step s leading to a desired result. The step s are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that the above and similar terms are to be associated with the appropriate physical quantities and are merely convenient labels applied to these quantities. Unless specifically stated otherwise, and as apparent from the following, it will be appreciated that throughout the present specification, discussions utilizing terms such as “scanning”, “calculating”, “determining”, “replacing”, “generating” “initializing”, “outputting”, or the like, refer to the action and processes of a computer system, or similar electronic device, that manipulates and transforms data represented as physical (electronic) quantities within the registers and memories of the computer system into other data similarly represented as physical quantities within the computer system memories or registers or other such information storage, transmission or display devices.

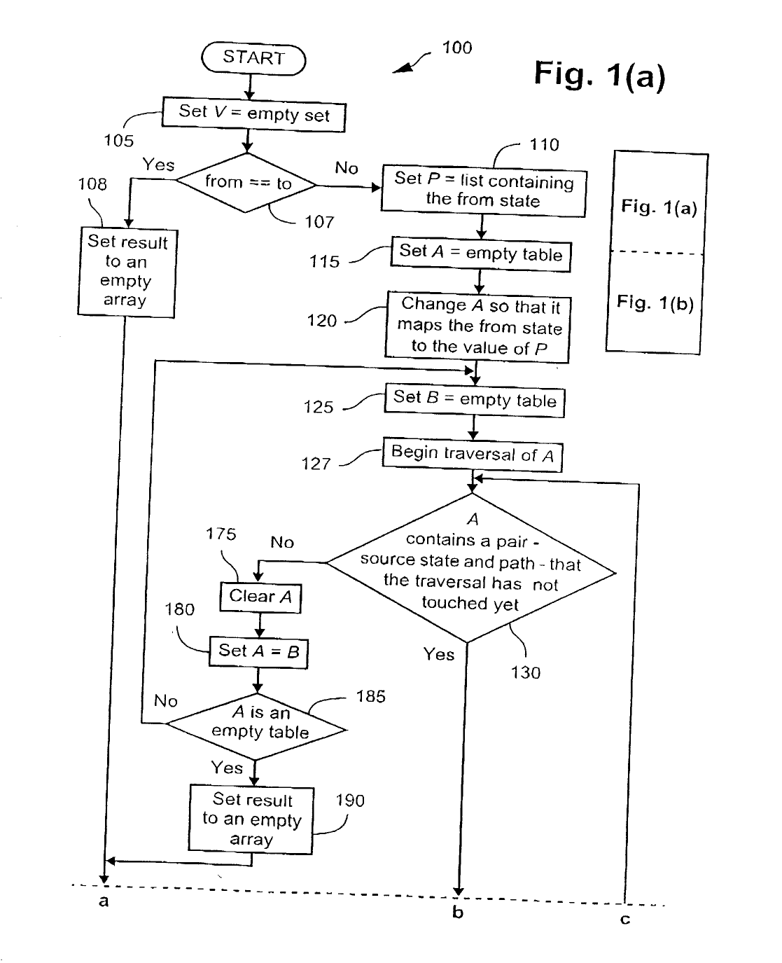

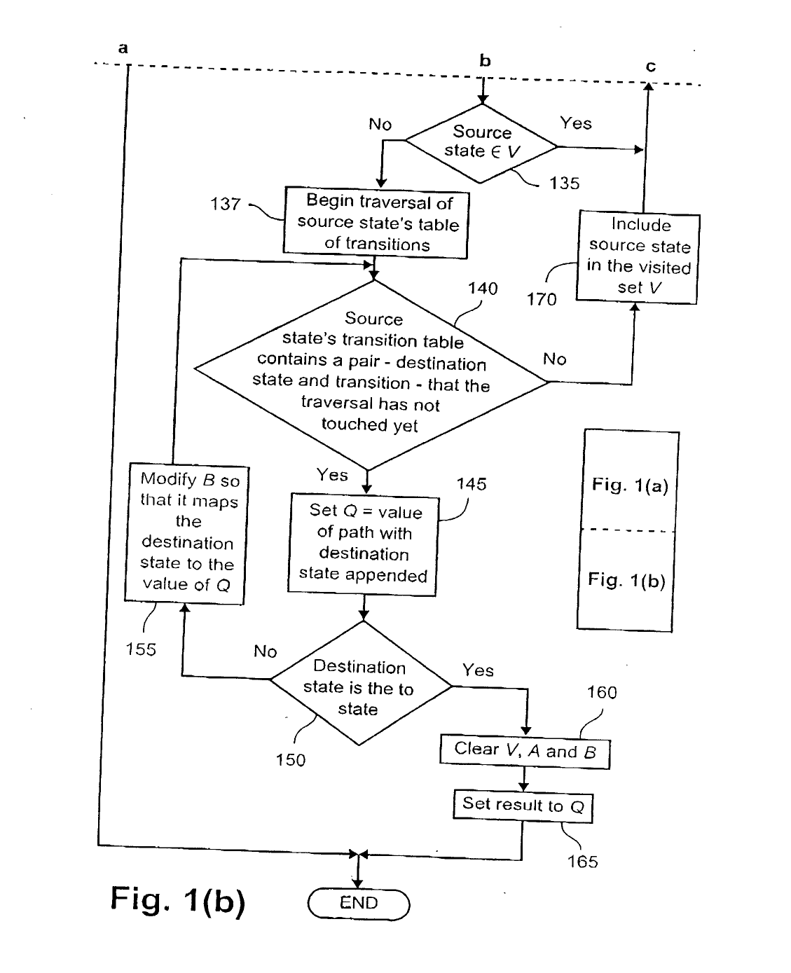

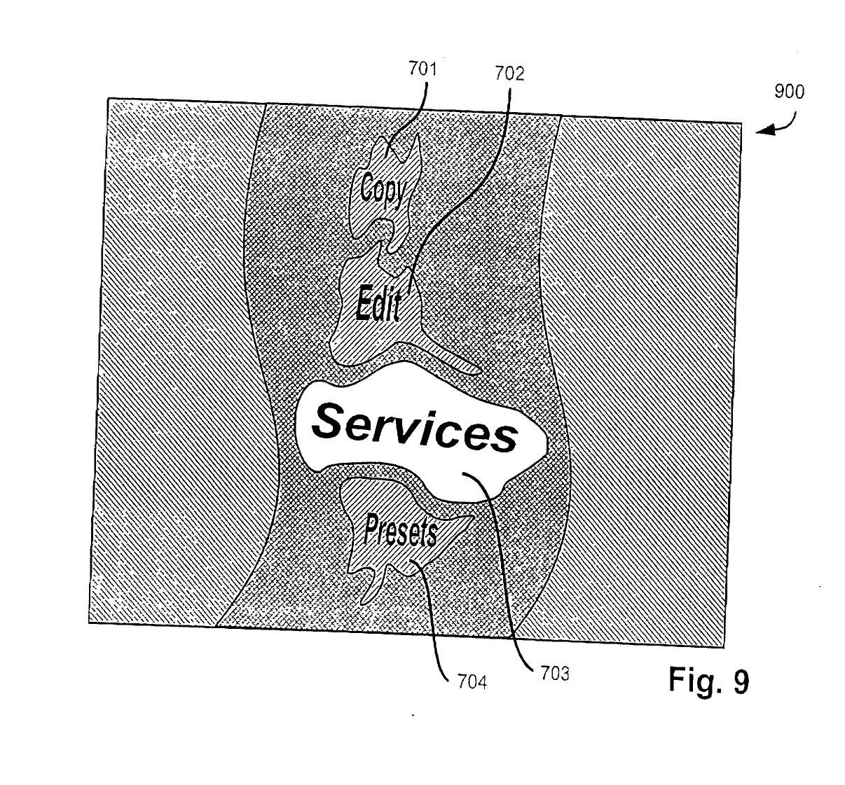

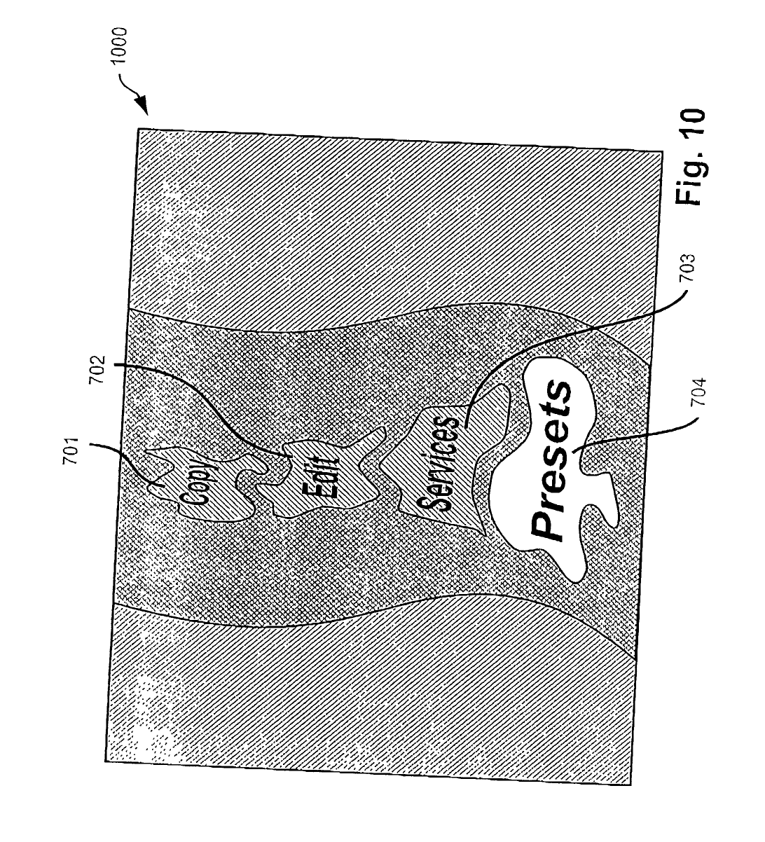

A number of methods for updating a graphical user interface are described below with reference to FIGS. 1 to 24. The methods described below enable the two roles of a designer and a programmer to be separated during the development of a graphical user interface. The described methods also enable independent changes to be made to the appearance and functioning of a graphical user interface.

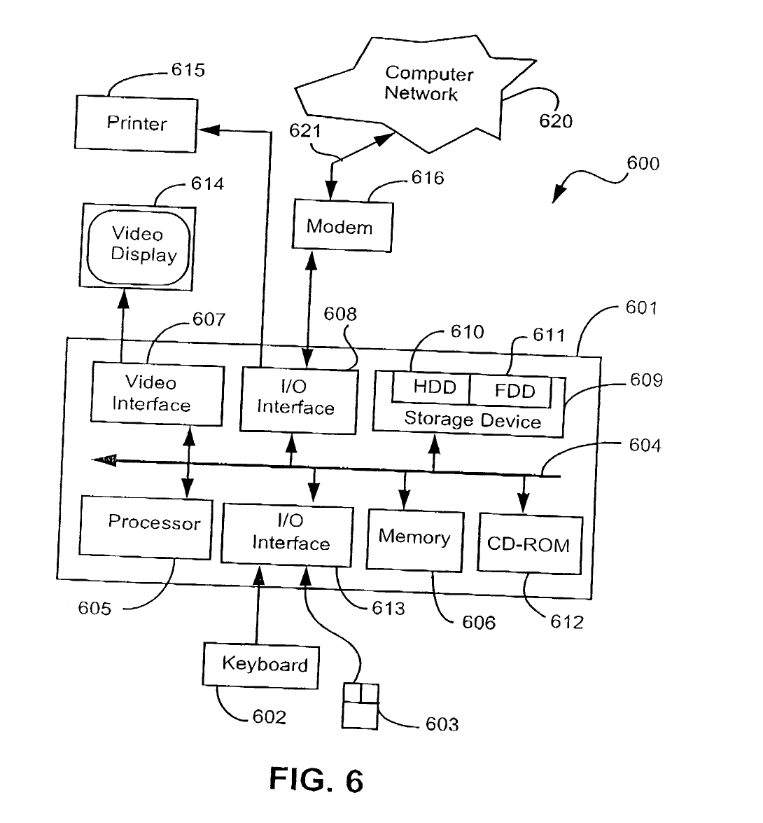

The methods described herein are preferably practiced using a general-purpose computer system 600, such as that shown in FIG. 6 wherein the processes of the described methods may be implemented using software, such as an application program executing in conjunction with a host graphical user interface system within the computer system 600. In particular, the step s of the methods described below with reference to FIGS. 1 to 5 and FIGS. 14 to 24 are effected by instructions in the software that are carried out by the computer. The instructions may be formed as one or more code modules, each for performing one or more particular tasks. The software may also be divided into two separate parts, in which a first part performs the methods described herein and a second part manages the host graphical user interface between the first part and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for performing the methods described herein.

The computer system 600 comprises a computer module 601, input devices such as a keyboard 602 and mouse 603, output devices including a printer 615 and a display device 614. The display device 614 can be used to display screens (ie. one or more visible graphical object components or text) of the host graphical user interface. A Modulator-Demodulator (Modem) transceiver device 616 is used by the computer module 601 for communicating to and from a communications network 620, for example, connectable via a telephone line 621 or other functional medium. The modem 616 can be used to obtain access to the Internet, and other network systems, such as a Local Area Network (LAN) or a Wide Area Network (WAN).

The computer module 601 typically includes at least one processor unit 605, a memory unit 606, for example formed from semiconductor random access memory (RAM) and read only memory (ROM), input/output (I/O) interfaces including a video interface 607, and an I/O interface 613 for the keyboard 602 and mouse 603 and optionally a joystick (not illustrated), and an interface 608 for the modem 616. A storage device 609 is provided and typically includes a hard disk drive 610 and a floppy disk drive 611. A magnetic tape drive (not illustrated) may also be used. A CD-ROM drive 612 is typically provided as a non-volatile source of data. The components 605 to 613 of the computer module 601, typically communicate via an interconnected bus 604 and in a manner which results in a conventional mode of operation of the computer system 600 known to those in the relevant art. Examples of computers on which the described arrangements can be practised include IBM-PC's and compatibles, Sun Sparcstations or alike computer systems evolved therefrom.

Typically, the application program is resident on the hard disk drive 610 and is read and controlled in its execution by the processor 605. Intermediate storage of the program and any data fetched from the network 620 may be accomplished using the semiconductor memory 606, possibly in concert with the hard disk drive 610. In some instances, the application program may be supplied to the user encoded on a CD-ROM or floppy disk and read via the corresponding drive 612 or 611, or alternatively may be read by the user from the network 620 via the modern device 616. Still further, the software can also be loaded into the computer system 600 from other computer readable media. The term “computer readable medium” as used herein refers to any storage or transmission medium that participates in providing instructions and/or data to the computer system 600 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 601. Examples of transmission media include radio or infra-red transmission channels as well as a network connection to another computer or networked device, and the Internet or Intranets including email transmissions and information recorded on websites and the like.

A control on a graphical user interface, can often be represented by a number of discrete states. For example, the appearance of a push button can be represented by “up”, “rollover” and “down” states. Further, more complicated controls such as menus and list boxes can be represented by combining together a number of simpler controls. As described above, a finite state machine can be in any one of many internal states at any one time and a state can change after each symbol of an input data string is read with the new state depending on the symbol just read and on the source state.

In contrast, the methods described herein can be implemented as part of an “Animated State Machine”. An animated state machine comprises a collection of object classes which together implement the animated state machine. These object classes comprise a collection of state objects, each of which corresponds to the visual appearance of a control. The state objects belong to a state object class and each state object has an associated mapping table used to map a particular state object to any associated object references, attribute identifiers and values. An animated state machine and state objects each have a number of associated procedures which will be described in detail below.

The animated state machine described herein also comprises a transition class which includes transition objects representing paths between different states within the animated state machine. Transition objects are used to determine the visual appearance of a graphical object corresponding to an animated state machine whenever the graphical object is “between states”. In particular, a transition object specifies the appearance of a graphical object at every point in time during a change between two states. Transition objects have a number of associated procedures, which will be described in more detail below.

Each transition object comprises a set of track objects belonging to a track object class. Track objects represent a facet (ie. part) of the transition of a graphical object between different states. A track object describes the values given to certain attributes of graphical objects. The values of the attributes are specified at corresponding times during a transition and generally all change in the same fashion, either smoothly or sharply. The track object class is an abstract class, instances of which contain lists of objects referred to as key objects representing track object change times. Track objects include a number of procedures, which will be described in detail below.

Key objects belong to a key object class and as described above, key objects represent track object change times. Key objects represent change times using the time at which a change occurs along the total duration of a state transition. Key objects also reference an associated track definition object containing relevant pairs of graphical object identifiers and associated graphical object attribute values. Key objects also include a number of procedures, which will be described in detail below.

Track definition objects belong to a track definition object class and as described above contain relevant pairs of graphical object identifiers and associated graphical object attribute values representing part of a state transition. Track definition objects also include a number of procedures, which will be described in detail below.

The transition between two states (eg. states A and B) of an animated state machine is represented by a transition object as described above. The transition object comprises the data defining the visual appearance of the animation and thus represents an animation of the visual appearance of the control at state A to the visual appearance of the control at state B.

In the methods described herein, when an animated state machine is formed by a designer, one of the states of the animated state machine is defined to be the initial state. The visual appearance of a control is set to be the appearance defined at the initial state which becomes the source state. When a user interacts with the control, there is generally a change in the visual appearance of the control with the new visual appearance being represented by one of the states of the animated state machine. Therefore, the control can be configured to request the state change from the source state to a desired destination state.

The animated state machine described herein utilises a shortest-path algorithm to determine an ordered collection of transition objects representing the change in the visual appearance of a control from the source state (ie. source state) to the desired destination state. This ordered collection of transition objects is referred to hereinafter as the “current route” of the animated state machine and represents the shortest route (ie. least number of state transitions) between a source state and a destination state. The shortest route is utilised while the animated state machine is animating in order to allow the animated state machine to determine one or more graphical objects, or parts thereof, that need to be rendered for a current frame. As transitions are completed, the completed transitions are removed from the current route of the animated state machine. When the current route is empty, the animated state machine is deemed to have arrived at the desired destination state, which becomes the source state. If a user attempts to interact with a control whilst the animated state machine of the control is currently in the process of animating a route, then the current route is modified to change the destination state of the animated state machine in order to reflect the new desired destination state. This change in the destination state can involve some or all of the existing current route being destroyed.

The combination of graphical objects forming a screen of a graphical user interface, is represented by an expression tree, as known in the art. The internal nodes of the expression tree define compositing operators, and leaf nodes of the expression tree define graphical primitives such as text, paths, images and plane fills. Nodes within the expression tree contain attributes which effect the visual appearance of the graphical objects forming the screen. Some examples of attributes are compositing operators, colour, opacity and stroke width. Any change to the visual appearance of a control can be implemented by one or more changes to the attributes associated with one or more nodes of an expression tree representing the screen of the graphical user interface which includes the control. These attribute changes can be encoded within the animation data stored within a transition object. The period of time taken to animate between any two states associated with a particular control is defined by a transition duration.

A transition object can also comprise a number of associated track objects, as described above, where each track object describes the values of one or more attributes of an expression tree representing the screen of the graphical user interface which includes the control. The attributes which a particular track object is capable of modifying are defined by the track definition object, as described above, associated with the track object. A track definition object contains an array of object-attribute pairs where many track objects can reference the same track definition object.

The animated state machine described herein exploits the fact that the visual appearance of an interface control can be completely defined by the value of the attributes of the expression tree representing the screen of the graphical user interface which includes the control. In addition, for any given control, generally some subset of the possible object attributes are never modified. Therefore, the values of the attributes which are modified at a particular time can be stored in order to define the visual appearance of the control. The animated state machine stores attributes associated with objects that will be modified during the course of state machine animations using the track definition objects of the track definition class (ie. ASM_TrackDef class). Each track definition object of the track definition class contains an array of object attribute pairs which define the attributes to be modified. All of the attributes listed within a single track definition object must be of the same type (ie. compositing operators, colour, opacity, stroke width or child nodes etc). However, a single track definition object can contain a number of related attributes which can be modified together. For example, the colour and alpha channel of a path node can be contained within a single track definition object.

A particular track definition object does not actually store any data values for the attributes specified by that track definition object. Attribute data is stored within object classes derived from an animated state machine key object (ie. ASM_Key) base class. Further, at least two object classes can be derived from the animated state machine key object base class. Firstly, an animated state machine key object double (ie. ASM_KeyDbl) class can be derived to store floating point data. Secondly, an animated state machine key object discrete (ie. ASM_KeyDiscrete) class can be derived to store arbitrary data, for example, integers and graphical objects (ie. GOBJ_Objects). Each key object references a track definition object which defines which attributes the data corresponds to, obviating the need for the key object to store the object-attribute pairs itself.

In the methods described herein, whenever an action is executed that requires a change in state for a particular control (eg. one or more graphical objects representing a button on the screen of a graphical user interface), a current route is calculated through the animated state machines representing the control. This current route comprises a list of one or more states that must be traversed to reach a destination state.

FIG. 1 is a flow chart showing a method 100 of determining a current route (ie. least number of state transitions) between a source state and a destination state for a particular control. The method 100 is preferably resident on the hard disk drive 610 of the computer system 600 and is read and controlled in its execution by the processor 605. The method 100 begins at step 105, where a set represented by the argument V is initialised by the processor 605 as an empty set. Elements representing visited transitions of the animated state machine associated with the control are added to the set V to indicate that a transition has been visited during a traversal (ie. at step 137 below) of a table of transitions associated with the source state. At the next step 107, the processor 605 compares the source state and the destination state to determine if the respective states are the same. If the source state and the destination state are not the same at step 107, then method 100 continues to the next step 110. Otherwise, the method 100 proceeds to step 108 where the result of the comparison is set to be an empty array stored in memory 606 and the method 100 concludes.

At step 110, the processor 605 sets an argument P to be a list containing the source state. At the next step 115, an argument A is set to be an empty table stored in memory 606. At the next step 120, the table represented by the argument A is modified so that the table maps the source state to the destination state. At the next step 125, an argument B is set to an empty table. At the next step 127, the table represented by A is traversed by the processor 605. At the next step 130, if the table A contains any mappings (ie. source state to destination state) that were not traversed at step 127 then the method 100 proceeds to step 135. Otherwise the method 100 proceeds to step 175, where the table represented by A is cleared. At the next step 180, the table represented by A is set to the value of B. At the next step 185, if the table represented by A is not empty then the method 100 returns to step 125. Otherwise, the method 100 proceeds to step 190 where the current route is set to an empty array in memory 606.

At step 135, if the source state is an element of the visited set V then the method 100 returns to step 130. Otherwise, the method 100 proceeds to step 137, where a table of transitions associated with the source state and stored in memory 606 is traversed. At the next step 140, if the transition table associated with the source state contains any mappings (ie. source state to destination state) that have not been traversed at step 137, then the method 100 proceeds to step 145. Otherwise, the method 100 proceeds to step 170, where an extra element representing the source state is added to the visited set V, and the method 100 returns to step 130.

At step 145, the argument Q is set by the processor 605 to the value of a path with the destination state appended. At the next step 150, if a destination state contained in the transition table is not equal to the destination state of the control then the method 100 proceeds to step 155. At step 155, the table represented by the argument B is modified so as to map the destination state to the value of the argument Q. If the destination state is equal to the destination state, at step 150, then the method 100 proceeds to step 160 where V, A and B are cleared. At the next step 165, the processor 605 sets the current route to the value of Q.

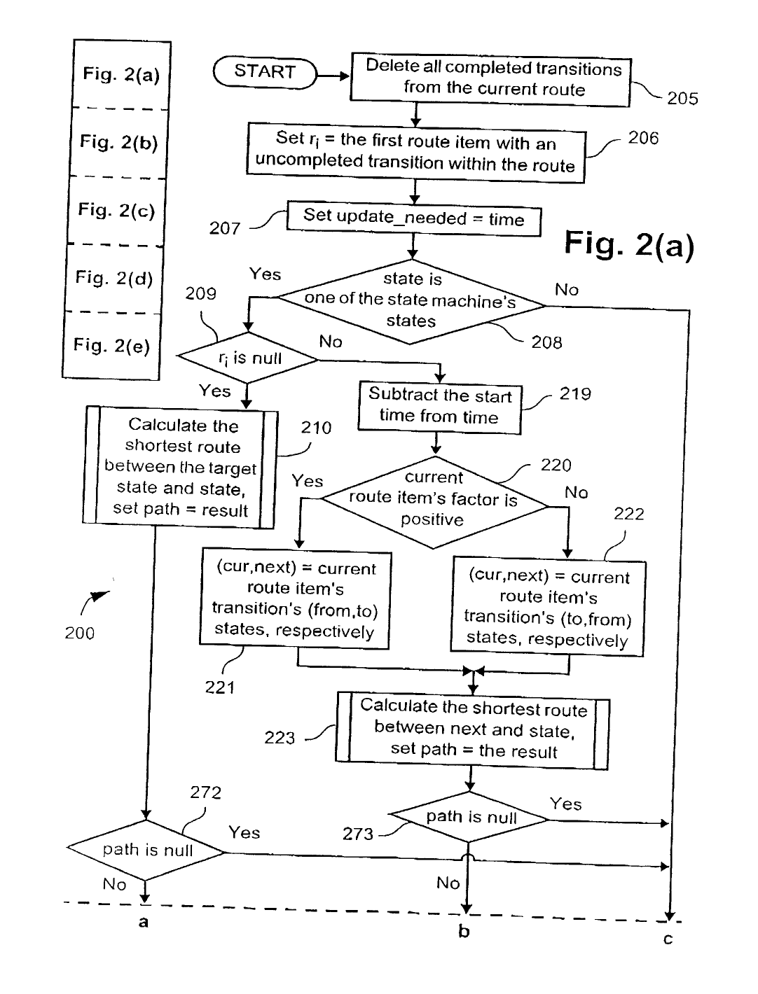

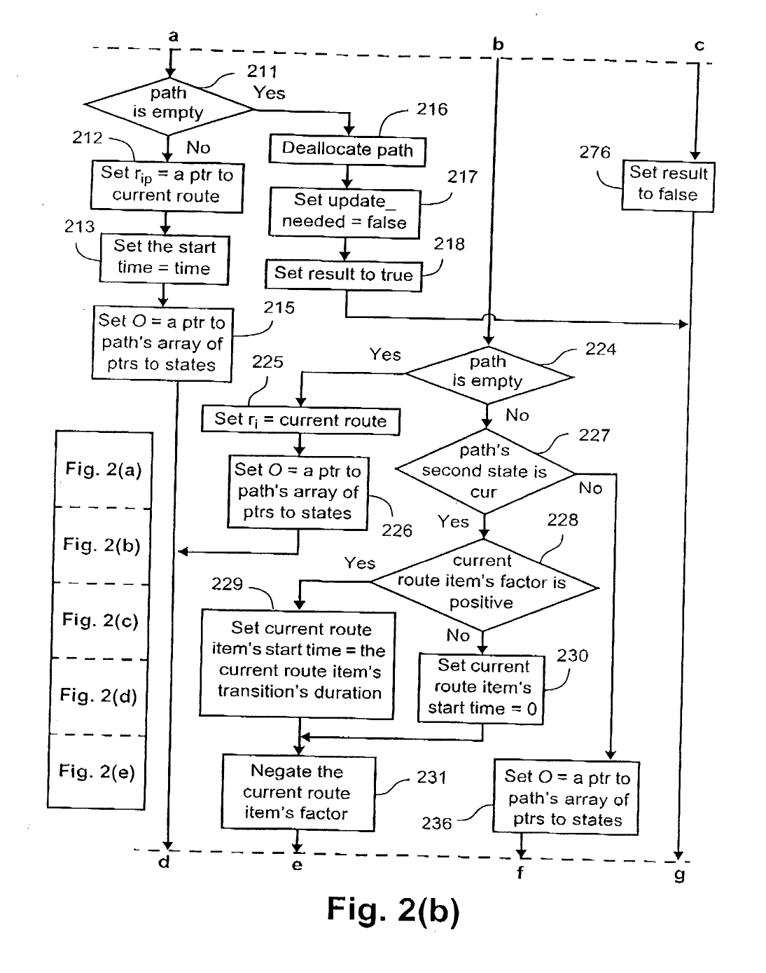

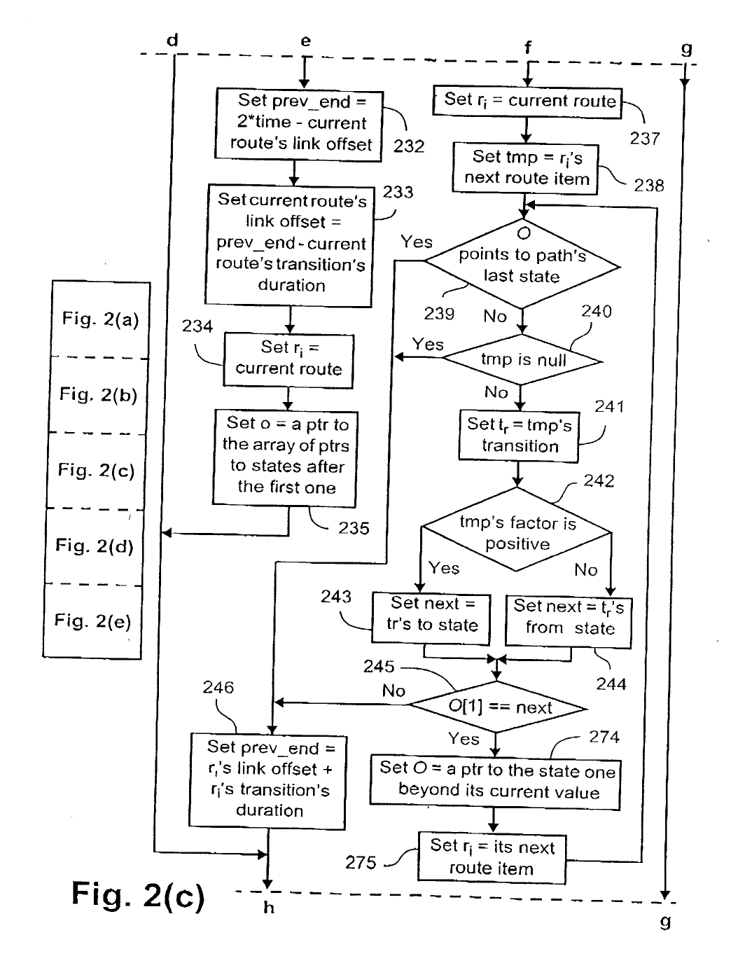

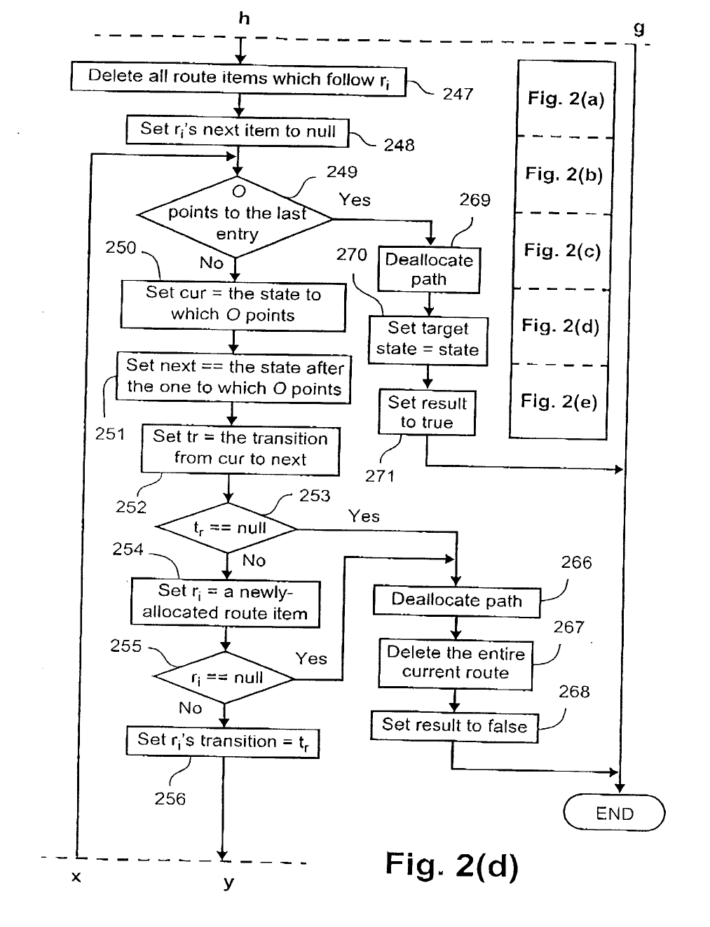

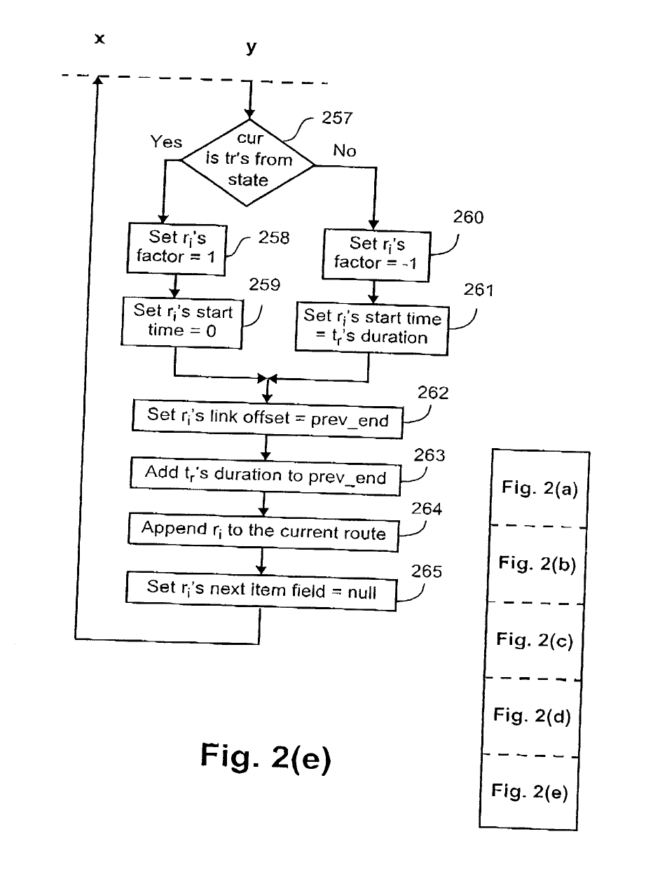

FIG. 2 is a flow chart showing a method 200 of determining a route to a new destination state for an animated state machine associated with a control of a graphical user interface. The method 200 determines the route to the new destination state based on the least number of transitions required to reach the destination state. The method 200 is preferably resident on the hard disk drive 610 of the computer system 600 and is read and controlled in its execution by the processor 605. The method 200 returns a result flag (ie. true) to be stored in memory 606 indicating whether the route to the new destination state has been successfully determined and a result flag (ie. false) indicating whether an error occurred. The method 200 begins at the first step 205, where the processor 605 deletes all completed transitions are deleted from the current route. At the next step 206, a pointer rᵢ is set to point to a first transition object with an uncompleted transition within the current route. At the next step 207, a flag represented by the label update_needed is set equal to true. At the next step 208, if the destination state is one of the states of the animated state machine then the method 200 proceeds to step 209. Otherwise, the method 200 proceeds to step 276 where a result argument is set to false indicating that a route to the new destination state for the animated state machine is not able to be determined and the method 200 concludes.

At step 209, if rᵢ is null then the method 200 proceeds to step 210 where the current route for a source state and the destination state, is calculated in accordance with the method 100, and the calculated route is assigned the label path. Otherwise the method 200 proceeds to step 219. At the next step 272, if the calculated route represented by path is null, then the method 200 proceeds to step 276. Otherwise the method 200 proceeds to step 211 where if path is empty then the method 200 proceeds to step 216 where path is deallocated (ie. deleted) and the memory associated with the label path is freed for later use. Otherwise the method 200 proceeds to step 212. At the next step 217, the update_needed flag is set to false. At the next step 218, the result flag is set to true and the method 200 concludes.

At step 212, a pointer rᵢₚ is set to the current route and stored in memory 606. At the next step 214, a label start_time is set equal to the present time. At the next step 215, a pointer represented by the label O is set to point to an array of pointers to states and the method 200 continues at the next step 247.

At step 219, a start time allocated to the first transition object is subtracted from the current time. The current time is determined from a clock associated with the computer system 600. At the next step 220, if the first transition object associated with the current route is positive then the method 200 proceeds to step 221, where the labels ‘cur’ and ‘next’ are set to be a source and destination state for the current route, respectively. Otherwise, the method 200 proceeds to step 222, where cur and next are set by the processor 605 to be a destination state and source state for the current route, respectively. At the next step 223, the current route for the state represented by next, and the destination state, is calculated in accordance with the method 100, and the calculated route is assigned the label path.

At the next step 273, if the calculated route represented by path is null, then the method 200 proceeds to step 276. Otherwise the method 200 proceeds to step 224 where if path is empty then the method 200 proceeds to step 225 where the pointer rᵢ is set to point to the current route. Otherwise, the method 200 proceeds to step 227. At the next step 226, a pointer represented by the label O is set to point to an array of pointers to states and the method 200 continues at the next step 247.

At step 227, if the second state of the route represented by path is equal to the state represented by the label cur then the method 200 proceeds to step 228. Otherwise the method 200 proceeds to step 236. At step 228, if a transition associated with the current route is positive then the method 200 proceeds to step 229, where the start time of the current route is set to the transition duration of the current route. Otherwise, the method 200 proceeds to step 230, where the start time of the current route is set to zero by the processor 605. At the next step 231, a factor associated with the current route is negated (ie. set equal to the negative of itself and multiplied by −1) by the processor 605. At the next step 232, an argument represented by the label prev_end_time is calculated by the processor 605 as follows for the current route:

prev_end_time=(2*time−the link offset)

where the link offset represents the time at which a current transition will begin to execute, relative to the start of execution of the current route. At the next step 233, a new value for the link offset of the current route is calculated by the processor 605 as follows:

link offset=(prev_end_time−the transition duration of the current route).

At the next step 234, the pointer rᵢ stored in memory 605 is set to point to the current route. At the next step 235, a pointer represented by the label O is set to point to an array of pointers to states after the first state.

If the second state of the route represented by path is not equal to the path represented by the label cur, at step 227, then the method 200 proceeds to step 236. At step 236, the pointer represented by the label O is set to point to an array of pointers to states stored in memory 605. At the next step 231, the pointer rᵢ is set to point to the current route. At the next step 238, a pointer tmp is set point to the next transition object of rᵢ and is stored in memory 606. At the next step 239, if the pointer O points to the last state of path, then the method 200 proceeds to step 246. At step 246, an argument prev_end representing the end time for the first transition object is calculated as follows:

prev_end=the link offset of rᵢ+the transition duration of rᵢ.

If the pointer O does not point to the last state of path, at step 239, then the method 200 proceeds to step 240. At step 240, if the pointer ‘tmp’ is null, then the method 200 proceeds to step 246. Otherwise, the method 200 proceeds to step 241 where the argument tᵢ is set equal to the transition of the route represented by tmp by the processor 605. At the next step 242, if the processor 605 determines that a factor associated with tmp is positive then the method 200 proceeds to step 243, where next is set equal to the destination state of tmp. Otherwise, the method 200 proceeds to step 244, where next is set equal to the source state of tmp.

At the next step 245, if the state that is one beyond the state pointed to be O (ie. O(1)), is the same as the state pointed to by next, then the method 200 proceeds to step 274. Otherwise, the method 200 proceeds to step 246. At step 274, the pointer O is incremented so as to point to the next state in path. At the next step 275, rᵢ is set equal to the next transition object and the method 200 returns to step 239.

At step 247, the processor 605 deletes all transition objects which follow rᵢ. At the next step 248, the next transition object of rᵢ is set equal to null. At the next step 249, if the pointer O points to the last entry in the array stored in memory 606, where the last entry represents the last state of the current route, then the method 200 proceeds to step 269. Otherwise, the method proceeds to step 250. At step 269, path is de-allocated. At the next step 270, the destination state of the state machine is set equal to that represented by state. At the next step 271, the result flag stored in memory 606 is set to true and the method 200 concludes.

At step 250, cur is set to the state in the path to which O is currently pointing. At the next step 251, next is set to the state in path beyond the one to which O is pointing. At the next step 252, tᵣ is set to the state transition from cur to next. If the processor 605 determines that tᵣ is null at the next step 253, then the method 200 proceeds to step 266. Otherwise, the method 200 proceeds to step 254 where rᵢ stored in memory 605 is set equal to a newly allocated transition object If rᵢ is null at the next set 255 then the method 200 proceeds to step 266. Otherwise the method 200 proceeds to step 256 where the transition of the route pointed to by rᵢ is set equal to tᵣ. At the next step 256, if cur is equal to the source state represented by the argument tᵣ then the method 200 proceeds to step 258. Otherwise, the method 200 proceeds step 260. At step 258, the factor associated with rᵢ is set equal to 1. At the next step 259, the start time of rᵢ is set equal to zero.

At step 260, the processor 605 sets the factor associated with rᵢ equal to −1. At the next step 261, the start time of rᵢ is set equal to the transition represented by tᵣ. At the next set 262, the link offset of rᵢ is set equal to prev_end. At the next step 263, the transition represented by tᵣ is set equal to prev_end. At the next step 264, the current transition object represented by rᵢ is appended to the current route. At the next step 265, a transition object field associated with rᵢ is set equal to null.

At step 266, the path is de-allocated. At the next step 267, the processor 605 deletes all of the transition objects of the current route. At the next step 268, the result flag stored in memory is set to false and the method 200 concludes.

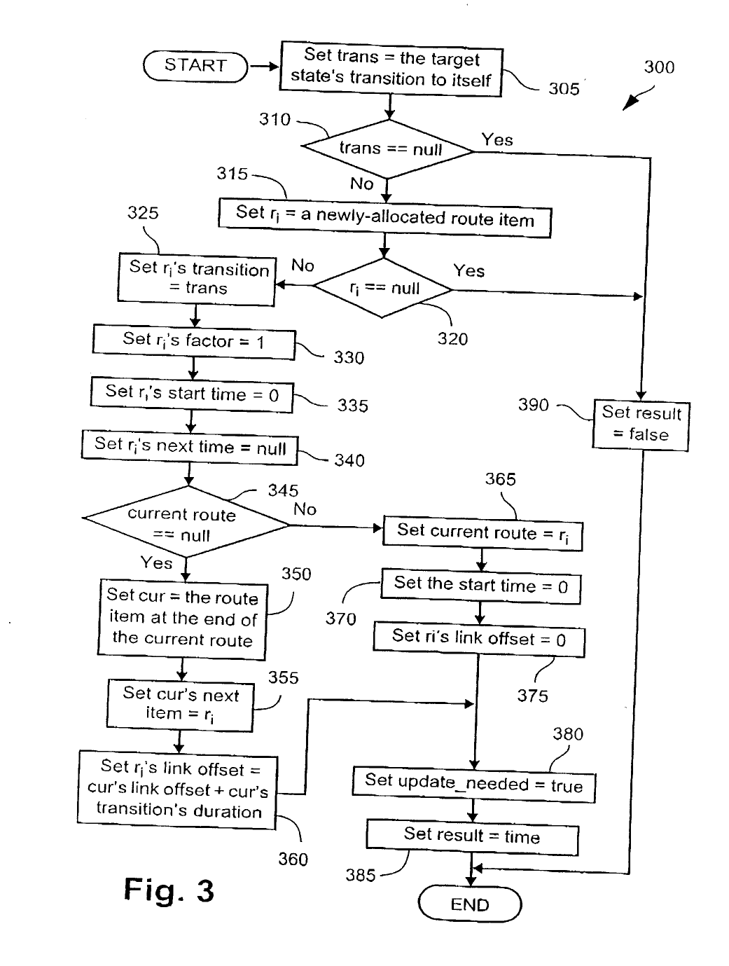

It is sometimes occurs that the state transition of a graphical object begins and ends at the same state but varies the appearance of the graphical object in between. Such a transition will be hereinafter referred to as a loop. FIG. 3 is a flow chart showing a method 300 of adding a new transition object to the end of the current route of an animated state machine associated with a control. The method 300 is preferably resident on the hard disk drive 610 of the computer system 600 and is read and controlled in its execution by the processor 605.

The method 300 returns a result flag (ie. true) to be stored in memory 606 indicating whether the new transition object has been successfully determined and a result flag (ie. false) indicating whether an error occurred. The method 300 begins at step 305, where an argument represented by the label trans is set to a transition associated with the current destination state of the animated state machine. At the next step 310, if trans is null, then the method 300 proceeds to step 390 where a result argument is set to false by the processor 605 and the method 300 concludes. Otherwise, the method 300 proceeds to step 315, where rᵢ, representing the next transition object with an uncompleted transition within the current route, is set to a newly allocated transition object (ie. memory is allocated for the new transition object). At the next step 320, if rᵢ is null, then the method 300 proceeds to step 390. Otherwise, the method 300 proceeds to step 325, where the transition of the transition object represented by rᵢ is set by the processor 605 to the transition represented by the label trans. At the next step 330, the factor associated with rᵢ is set equal to 1. At the next step 335, the start time of the transition object represented by rᵢ is set to 0. At the next step 340, the next transition object associated with rᵢ is set to null.

At the next step 345, if the current route is not null, then the method 300 proceeds to step 350, where cur is set to the transition object at the end of the current route. Otherwise, the method 300 proceeds to step 365. At the next step 355, the next item field of cur is set to the transition object represented by rᵢ. At the next step 360, the link offset associated with the transition object represented by rᵢ is set equal to the sum of the link offset associated with the transition object associated with cur and the transition duration of the transition object associated with cur.

At step 365, the current route of the state machine is set to rᵢ. At the next step 370, the processor 605 sets the start time of the state machine to 0. At the next step 375, the link offset associated with rᵢ is set to zero.

At the next step 380, the update_needed flag is set to true. At the next step 385, the result flag stored in memory 606 is set to true and the method 300 concludes.

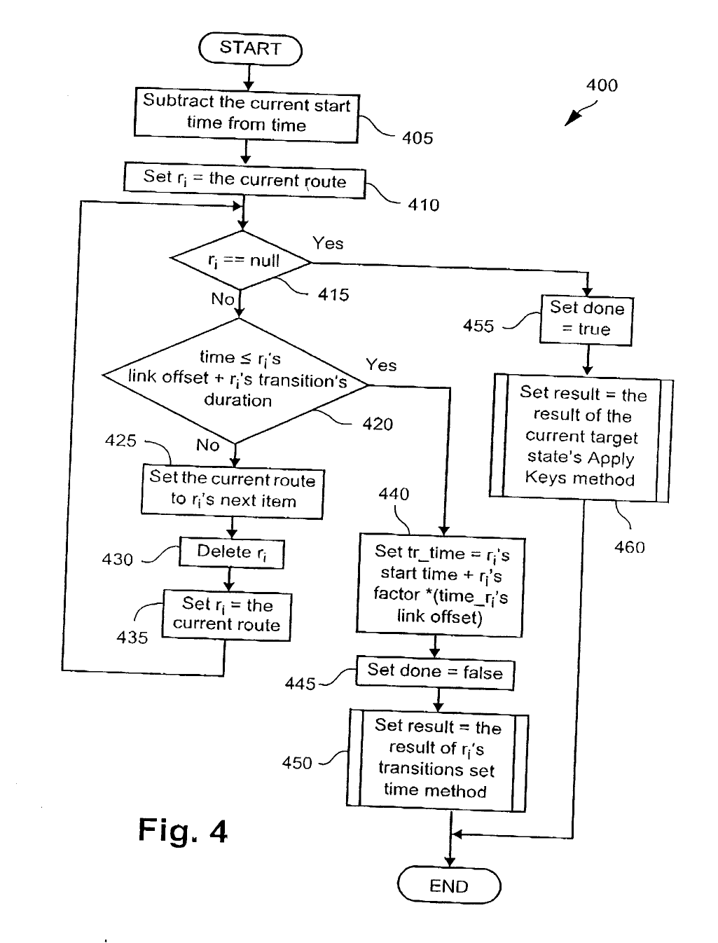

During or after the transition of an animated state machine, it is necessary to update the appearance of any graphical object associated with the animated state machine. FIG. 4 shows a flow chart showing a method 400 of updating the appearance of any graphical objects associated with the animated state machine of FIGS. 1 to 3. The method 400 is preferably resident on the hard disk drive 610 of the computer system 600 and is read and controlled in its execution by the processor 605. The method 400 requires a state machine and a variable time stored in memory 606 and measured according to a clock of the system 600, and returns a done flag to be stored in memory to indicate whether the current route of the state machine has finished the current animation, and a result flag (ie. false) stored in memory 606 to indicate whether an error occurred. The method 400 begins at step 405, where the start time allocated to the state machine during the methods 100, 200 and 300, is subtracted from the current time. At the next step 410, the argument rᵢ is set to the current route. At the next step 415, if rᵢ is null, then the method 400 proceeds to step 455, where a done flag is set to true. Otherwise the method 400 proceeds to step 420. At the next step 460, the result flag is set to the result of calling an ‘ApplyKeys’ procedure for the source state of the state machine. The ApplyKeys procedure accepts a reference associated with self and examines a table of key objects associated with the transition object representing the source state. The ApplyKeys procedure retrieves the key object references, attribute identifiers and associated attribute values, and then sets attribute values associated with each key object according to the source state.

At step 420, if time is less than or equal to the sum of the link offset for the current route and the transition duration of the current route, then the method 400 proceeds to step 425. Otherwise, the method 400 proceeds to step 440, where the argument tr_time representing a, “pseudo-time” that can be used to calculate the appearance of a graphical object, is set equal to:

tr_time=rᵢ (start time)+rᵢ (factor)×(time−rᵢ (link offset)).

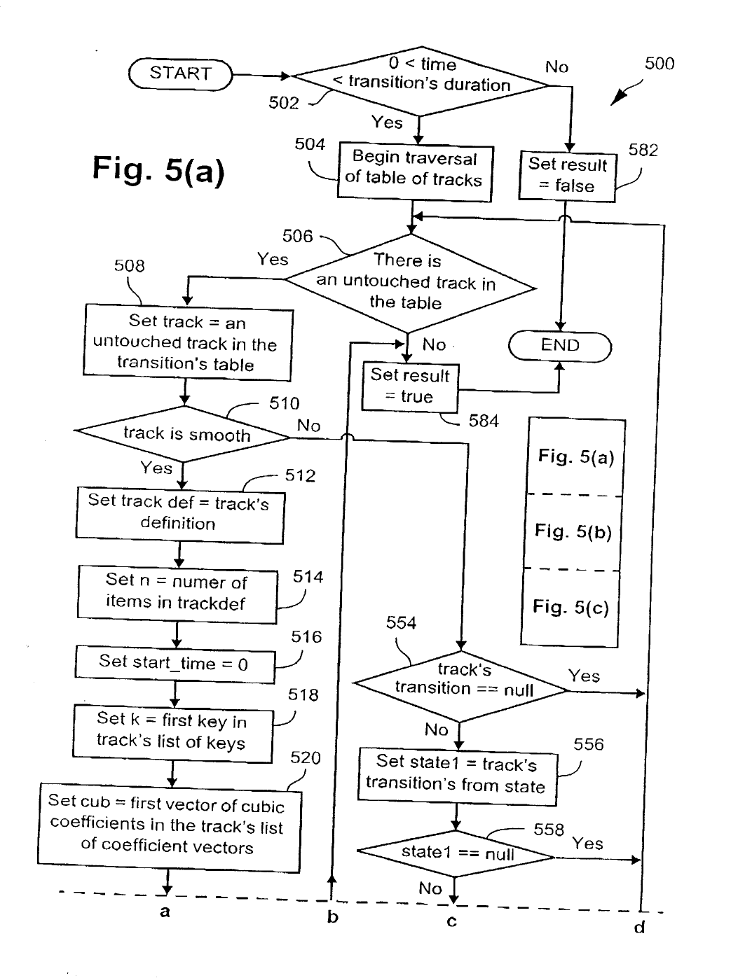

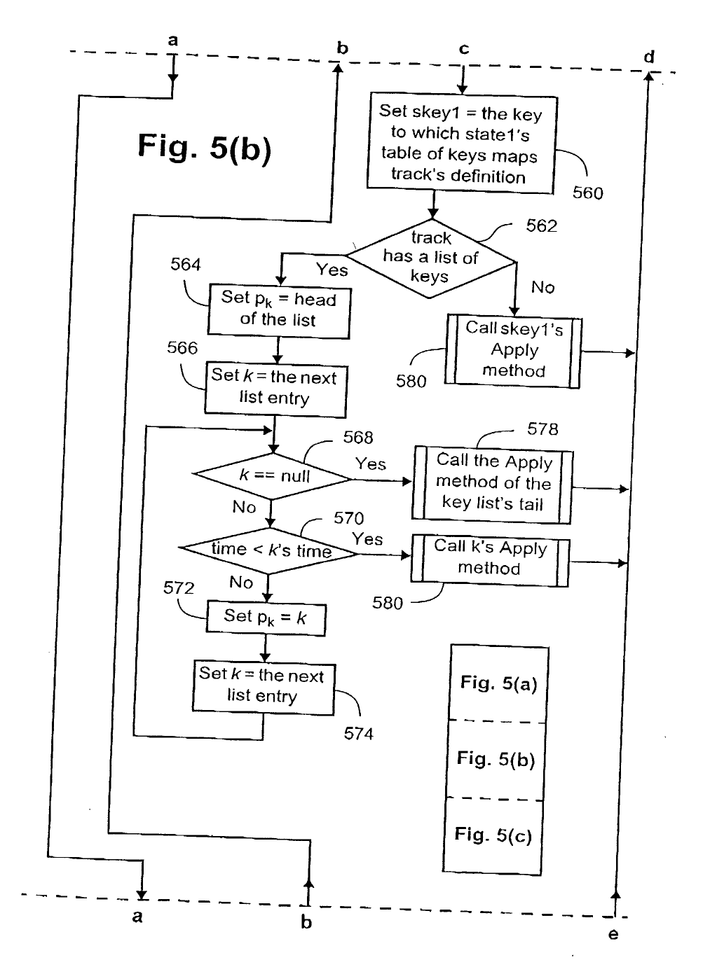

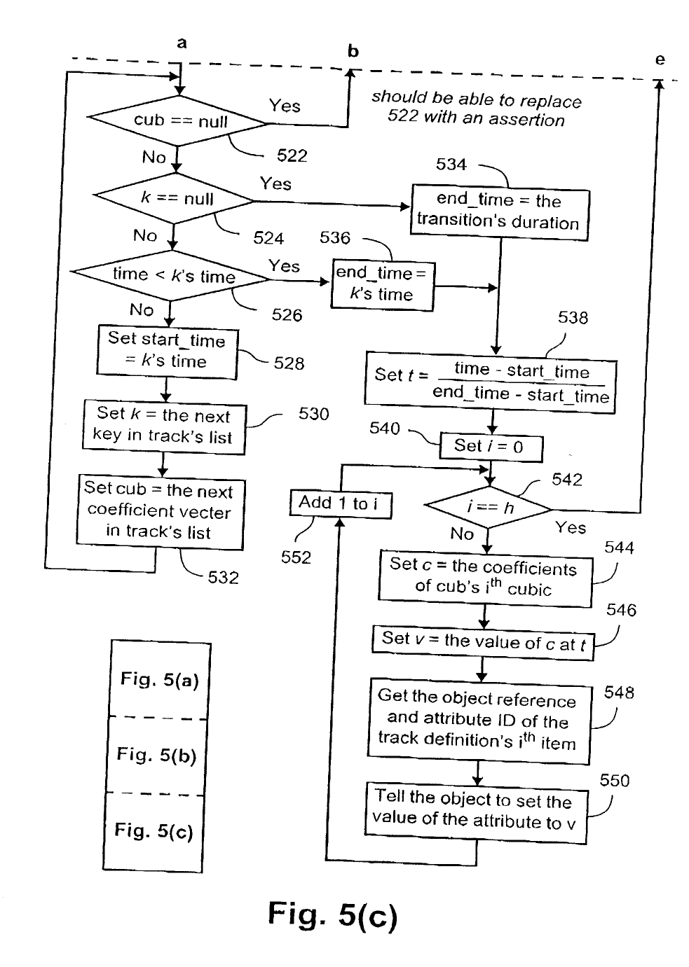

At the next step 445 the done flag is set to false. At the next step 450, the result flag is set to the result of calling the method 500 (See FIG. 5) for the transition of the current route of the source state for the state machine and the method 400 concludes. As will be described below, the method 500 traverses the track objects of a transition object and selects an unused track object. The unused track object is then used to update any graphical objects associated with the transition object.

At step 425, the current route is set to the next item of rᵢ. At the next step 430, the processor 605 deletes rᵢ. At the next step 435, rᵢ is set equal to the current route and the method 400 returns to step 415.

FIG. 5 is a flow chart showing the method 500 of updating the state of a graphical object during a particular transition. The method 500 is preferably resident on the hard disk drive 610 of the computer system 600 and is read and controlled in its execution by the processor 605. The method 500 returns a result flag to be stored in memory 606 indicating whether any graphical objects were updated (ie. true), or whether an error occurred (ie. false) The method 500 begins at step 502, where if the variable time stored in memory 606 is greater than or equal to zero or less than or equal to the duration of the transition, then the method 500 proceeds to step 504. Otherwise, the method 500 proceeds to step 582, where the result flag is set to false and the method 500 concludes.

At step 504, the track objects associated with the transition are examined by traversing a table of track objects associated with the transition and stored in memory 606. At the next step 506 if there are no unused track objects associated with the transition then the method 500 proceeds to step 584 where the result flag is set to true and the method 500 concludes. Otherwise, the method 500 proceeds to step 508 where an argument track stored in memory 606 is set to a first unused track object in the track table associated with the transition. At the next step 510 if the first unused track object represents a discrete track then the method 500 proceeds to step 554. Otherwise, if the unused track object represents a smooth track then the method 500 proceeds to step 512. At step 512, an argument trackdef stored in memory 606 is set to the track definition of the selected track object. At the next step 514, an argument n stored in memory 606 is set to the number of transition objects represented by the trackdef. At the next step 516 the argument start_time representing the start time of selected unused track objects is set to zero. At the next step 518, an argument k stored in memory 606 is set to the first key object in a list of key objects associated with the selected unused track object. At the next step 520, an argument cub stored in memory 606 is set equal to the first vector of cubic coefficients in a list of coefficient vectors associated with the selected unused track object. At the next step 522, if cub is null, then the method 500 proceeds to step 584. Otherwise, the method 500 proceeds to step 524, where if k is null then the method 500 proceeds to step 534. If k is not null at step 524, then the method 500 proceeds to step 526, where if the value of time is less than the time represented by a time field associated with k then the method 500 proceeds to step 536. Otherwise, the method 500 proceeds to step 528, where the processor 605 sets start_time to the time represented by the field associated with k. At the next step 530, k is set to the next key in the list of key objects associated with the selected unused track. At the next step 532, cub is set to the next coefficient vector in the list of coefficient vectors associated with the selected unused track object.

At step 534, an argument end_time stored in memory 606 and representing the finish time of the selected unused track object is set to the duration of the transition and the method 500 proceeds to step 538.

At step 536, the argument end_time representing the finish time of the selected unused track object is set to the time represented by the time field associated with k and the method 500 proceeds to step 538.

At step 538, an argument t stored in memory 606 and representing a normalised time (ie. between 0 and 1) suitable for linear and cubic (Bezier) spline interpolation, is calculated as follows:

t=(time−start_time)/(end_time−start_time).

At the next step 540, a counter i stored in memory 606 is set to 0. At the next step 542, if i is equal to n then the method 500 returns to step 506. Otherwise, at the next step 544, an argument c stored in memory 606 is set to the coefficients of the ith cubic of cub. At the next step 546, an argument v is set to the value of c at t (ie. v=c0+t×(c1+i×(c2+t×c3)). At the next step 548, the object reference and attribute identifier associated with the ith track object of the track definition are examined by the processor 605. At the next step 550, the value of the identified attribute associated with the referenced track object is set to v and the method 500 proceeds to step 552. At step 552, the counter i is incremented by 1 and the method 500 returns to step 542.

As described above, at step 510, if the first unused track object represents a discrete track then the method 500 proceeds to step 554. At step 554, if the transition of the unused track object is null then the method 500 returns to step 506. Otherwise, the method 500 proceeds to step 556, where an argument state1 is set to the source state of the transition object associated with the unused track object. If state1 is null then the method 500 returns to step 506. Otherwise the method 500 proceeds to step 560. At step 560, an argument skey1 is set equal to the key object which the table of key objects associated with state1 maps the track definition. At the next stop 562, if the unused track object has a list of key objects then the method 500 proceeds to step 564, where a pointer pk stored in memory 606 is set to point to the head of the list. Otherwise, if the unused track object does not have a list of key objects at step 560 then the method 500 proceeds to step 580, where an Apply Method associated with the key object represented by skey1 is called by the processor 606 and the method 500 returns to step 506. As described above, a key object maps object attribute pairs to associated graphical object attribute values. The Apply Method examines the object-attribute pairs stored in the key object represented by skey1 and sets the object attribute pairs to the corresponding values. At the next step 566, the argument k is set to the next key object in the list of key objects. At the next step 568, if k is null then the method 500 proceeds to step 578 where the Apply Method of the last key object in the list is called by the processor 605 and the method 500 returns to step 506. Otherwise, if the argument k is not null then the method 500 proceeds to step 570. At step 570, if the variable time is less than or equal to the time represented by the time field associated with k the Apply Method associated with k is called by the processor 605 and the method 500 returns to Stop 506. Otherwise, the method 500 proceeds to step 572, where the pointer pk is set to point to k representing current item in the list of key objects. At the next step 574, k is set to the next entry in the list of key objects associated with the current unused track objects and the method 500 returns to step 568.

In graphical user interface systems, it is common for there to be one or more graphical objects which are capable of accepting keyboard events active at any one time. Most graphical user interface systems use a concept referred to as “keyboard focus”. In accordance with the keyboard focus concept, at all times there is one graphical object component of the graphical user interface system that is receiving all input keyboard events. Objects that deal with keyboard focus are generally referred to as focus event handler objects and belong to a focus event handler object class which provides an abstract base class for functionality that is common to all focus event handler objects within the focus event handler object class. One such characteristic is that almost all focus event handler objects transfer focus between sibling focus event handler objects, via a focus transferral protocol. The focus transferral protocol is used for transferring the focus between different objects. The focus transferral protocol is used to support a hierarchical keyboard focus model, whereby an object can have the focus only if the parent object of the object also has the focus. The focus transferral protocol has two sides as follows:

sender: The sender side of the protocol includes the message set_focus to indicate that the emitting object is giving focus to the receiving object, and

receiver: The receiver side of the protocol does not include any messages.

In the methods described herein, a protocol referred to as ‘Keyboardraw’ can be used to transmit raw input from the keyboard 602, for example, in the form of untranslated character codes to event handler objects. The Keyboardraw protocol has two sides as follows:

sender: The sender side of the protocol includes the messages key_down and key_up to indicate that a key on the keyboard (eg. 602) has been pressed; and

receiver: The receiver side of the protocol includes the message set_capture to indicate that the code associated with a pressed key has been read and translated.

Graphical user interface systems often have menu systems that involve switching between different screens of the graphical user interface. In the methods described herein, a menu screen control protocol object can be used for communication between event handler objects for different menu screens with a higher-level event handler object coordinating different screens. The menu screen control protocol has two sides as follows:

sender: The sender side of the protocol includes the messages left, up, right, down, action, and set_visibility to indicate what state a particular menu item on a particular menu screen should be in at a particular time; and

receiver: The receiver side of the protocol includes the message focus_transferred to indicate to a parent menu item that a menu item has received focus from a sibling menu item.

Some menu systems have various items where only one item is active at any particular time. A menu item control protocol object can be used for communication between event handler objects for different menu item event handler objects with a higher-level event handler object controlling a screen. The menu item control protocol has two sides as follows:

sender: The sender side of the protocol includes the messages left, up, right, down, action, and set_visibility to indicate what state a particular menu item should be in at a particular time; and

receiver: The receiver side of the protocol includes the messages focus_transferred and pressed to indicate to a parent menu item that a menu item has received focus from a sibling menu item.

In the methods described herein, event handler objects can be connected and disconnected at the runtime of an application program (ie. the time at which the application program begins to execute). Further, one event handler object can be replaced with another, whether or not the event handler objects are of the same class, provided that the replacing event handler object has interfaces compatible with all protocols with which the original event handler object was communicating.

Event handler objects have ‘connect’, ‘disconnect’, ‘emitsingle’, ‘emitall’, ‘emitallothers’, ‘emituntil’, and invoke procedures, which will be described below. Event handler objects also include a procedure to copy interfaces to an object from a class (ie. object template). Every event handler object has a table of interfaces keyed by an interface identifier. An interface identifier can be mapped to one or more event handler objects with each interface identifier having an associated protocol reference and side identifier.

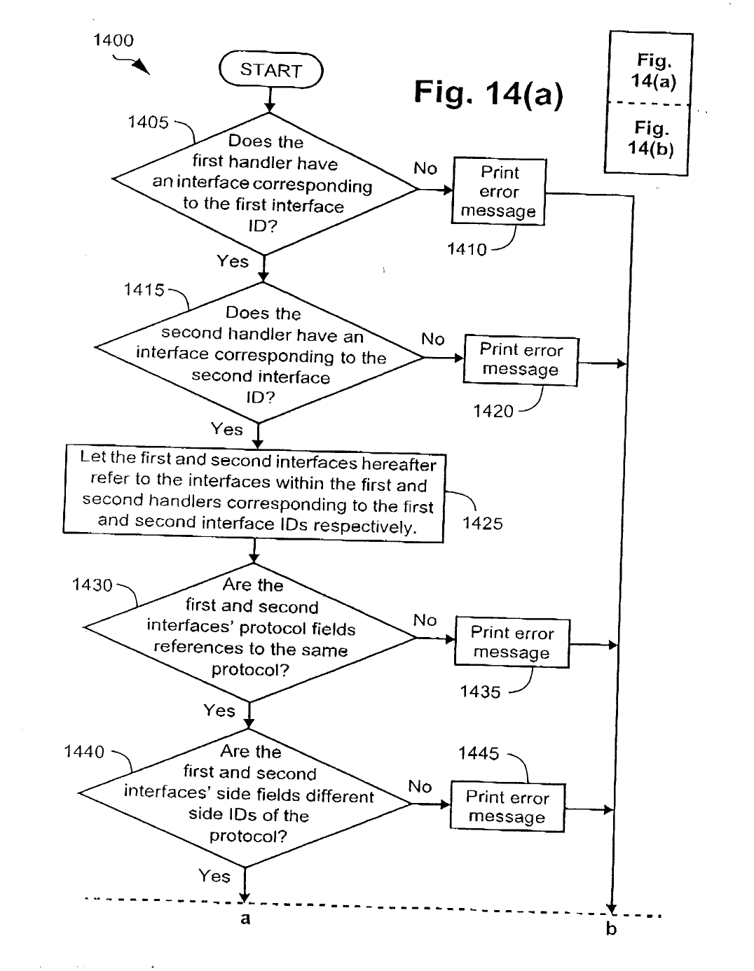

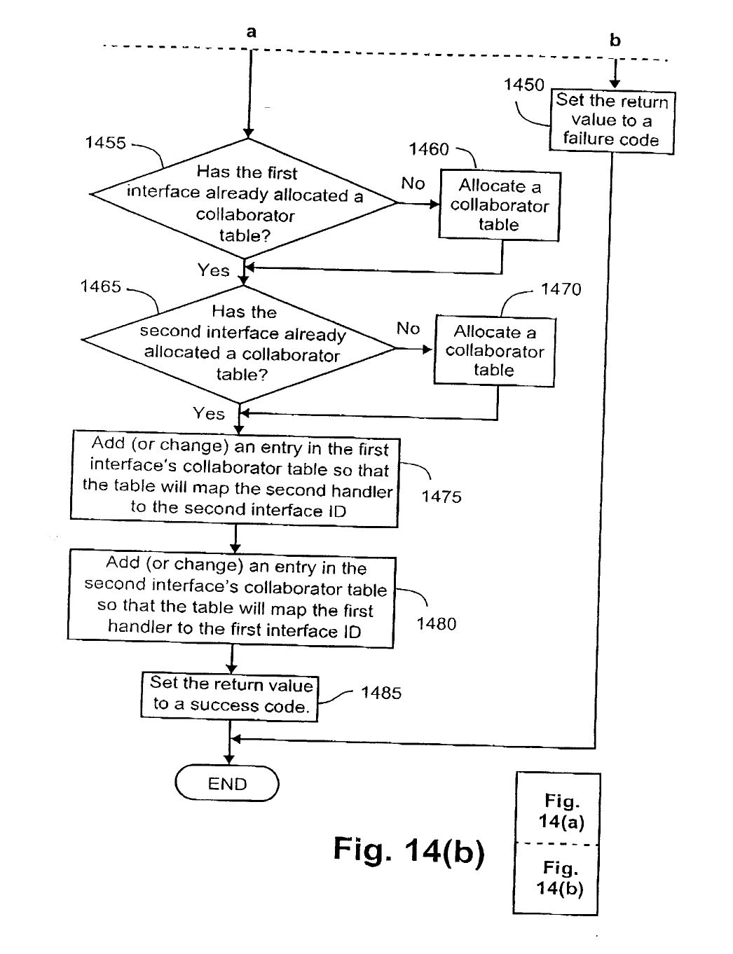

FIG. 14 is a flow diagram showing a method 1400 of connecting two event handler objects (ie. a first event handler object and a second event handler object) in accordance with the connect procedure. The method 1400 of FIG. 14 is preferably implemented using software resident on the hard disk drive 610 of the computer system 600 and is read and controlled in its execution by the processor unit 605. The method 1400 has the following input parameters: a reference associated with the first event handler object (ie. the emitting event handler object); an interface identifier identifying the interface of the first event handler object; reference to the second event handler object (ie. the receiving object); and an interface identifier identifying the interface of the second event handler object. The method 1400 determines that the interface of the first event handler object and the second event handler object are defined and present in the corresponding first and second event handler objects. The method 1400 also determines that both interfaces communicate by the same protocol and that both interfaces correspond to different sides of the protocol. The method 1400 is configured to add an entry to a collaborator table associated with the interface of the first event handler object and stored in memory 606. The collaborator table is used to map an event handler object to an interface identifier. The collaborator table is keyed by a reference associated with the second event handler object and stores the value of the interface identifier of the second event handler object in memory 606. The method 1400 is also configured to add an entry to the collaborator table of the interface associated with the second event handler object. The entry is the interface identifier of the first event handler object.

The method 1400 begins at the step 1405 where a test is performed to determine if the first event handler object has an associated interface identifier corresponding to a first predetermined interface identifier. If the first event handler object has an associated interface identifier corresponding to the first predetermined interface identifier, at step 1405, then the method 1400 proceeds to step 1415. Otherwise, the method 1400 proceeds to step 1410, where an error message is generated. Following step 1410, the method 1400 proceeds to step 1450 where a failure message is generated, the connection of the event handler objects is aborted and the method 1400 concludes.

At step 1415, if the second event handler object has an associated interface identifier corresponding to a second predetermined interface identifier then the method 1400 proceeds to step 1425. Otherwise, the method 1400 proceeds to step 1420, where an error message is generated by the processor 605. Following step 1420, the method 1400 proceeds to step 1450 where a failure message is generated and the connection of the event handler objects is aborted.

At step 1425, a first interface is set to be the interface within the first event handler object corresponding to the first interface identifier and a second interface is set to be the interface within the second event handler object corresponding to the second interface identifier.

At step 1430, a test is performed by the processor 605 to determine if the first and second interfaces use the same protocol. If the first and second interfaces do not use the same protocol, then the method 1400 continues at step 1435, where an error message is generated. Otherwise the method 1400 continues at step 1440. Following step 1435, the method 1400 proceeds to step 1450 where a failure message is generated and the connection of the event handler objects is aborted.

At step 1440, a test is performed to determine if the first and second interfaces use different sides of the same protocol. If the first and second interfaces do use different sides of the same protocol, then the method 1400 continues at step 1445, where an error message is generated. Otherwise the method 1400 continues at decision block 1455. Following step 1455, the method 1400 proceeds to step 1450 where a failure message is generated by the processor 605 and the connection of the event handler objects is aborted.

At step 1455, a test is performed by the processor 605 to determine if the first interface has an allocated collaborator table stored in memory 605. If the first interface has an allocated collaborator table, then the method 1400 proceeds to step 1460, where the first interface is allocated a collaborator table stored in memory 605. Otherwise, the method 1460 proceeds to step 1465.

At step 1465, the processor 605 performs a test to determine if the second interface has an allocated collaborator table stored in memory 606. If the second interface has an allocated collaborator table, then the method 1400 proceeds to step 1470, where the second interface is allocated a collaborator table. Otherwise, the method proceeds to step 1475.

At step 1475, an entry is added or changed in the collaborator table allocated to the first interface so that the table maps the second event handler object to the second interface identifier. The entry is the interface identifier of the first event handler object. At the next step 1480, an entry is added or changed in the collaborator table allocated to the second interface so that the table maps the first event handler object to the first interface identifier. The entry is the interface identifier of the second event handler object. At the next step 1485, a success message is generated by the processor 605 and the method 1400 concludes.

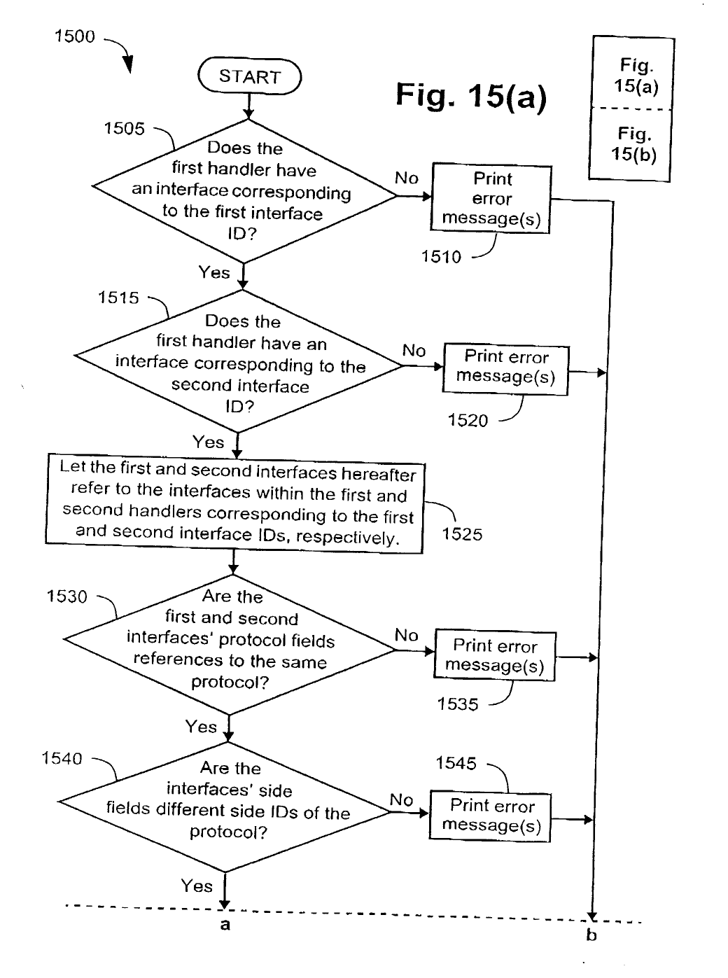

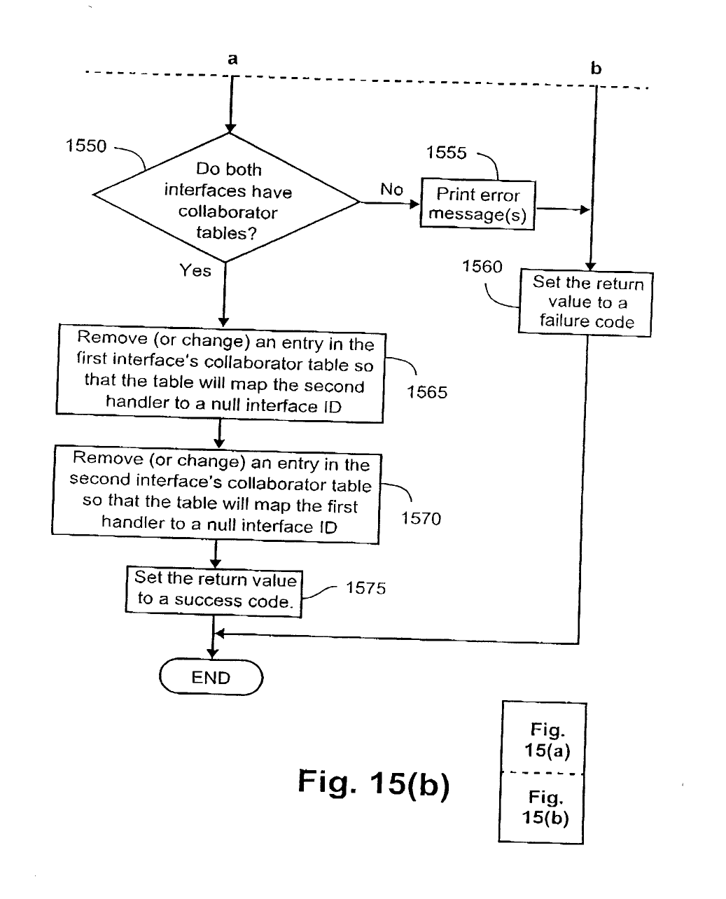

FIG. 15 is a flow diagram showing a method 1500 of disconnecting two event handler objects (ie. a first event handler object and a second event handler object) in accordance with the disconnect procedure. The method 1500 of FIG. 15 is preferably implemented using software resident on the hard disk drive 610 of the computer system 600 and is read and controlled in its execution by the processor unit 605. The method 1500 has the following input parameters: a reference associated with the first event handler object; an interface identifier identifying the interface of the first event handler object; a message identifier; and a reference associated with an argument list to be passed. The method 1500 determines that the interface of the first event handler object and the second event handler object are defined and present in the corresponding first and second event handler objects. The method 1500 is configured to determine that both interfaces communicate by the same protocol and that both interfaces correspond to different sides of the protocol. The method 1500 is also configured to remove any entry from the collaborator table stored in memory 606 and being associated with the interface of the first event handler object. The method 1500 is also configured to remove any entry from the collaborator table of the interface associated with the second event handler object.

The method 1500 begins at step 1505, where a test performed by the processor 605 to determine if the first event handler object has an associated interface corresponding to a first predetermined interface identifier. If the first event handler object has an associated interface corresponding to the first predetermined interface identifier, then the method proceeds to step 1515. Otherwise, the method 1500 proceeds to step 1510, where an error message is generated. Following step 1510, the method 1500 proceeds to step 1560 where a failure message is generated by the processor 605, the disconnection of the event handler objects is aborted and the method 1500 concludes

At step 1515, the processor 605 performs a test to determine if the second event handler object has an associated interface corresponding to a second predetermined interface identifier. If the second event handler object has an associated interface corresponding to the second predetermined interface identifier, then the method proceeds to step 1525. Otherwise, the method 1500 proceeds to step 1520, where an error message is generated by the processor 605. Following step 1520, the method 1500 proceeds to step 1560 where a failure message is generated, the disconnection of the event handler objects is aborted and the method 1500 concludes.

At step 1525, a first interface is set to be the interface within the first event handler object corresponding to the first interface identifier and a second interface is set to be the interface within the second event handler object corresponding to the second interface identifier.

At step 1530, a test is performed to determine if the first and second interfaces use the same protocol. If the first and second interfaces do not use the same protocol, then the method 1500 continues at step 1535, where an error message is generated by the processor 605. Otherwise the method 1500 continues at step 1540. Following step 1535, the method 1500 proceeds to step 1560 where a failure message is generated by the processor 605 and the disconnection of the event handler objects is aborted.

At step 1540, the processor 605 determines if the first and second interfaces use different sides of the same protocol. If the first and second interfaces do use different sides of the same protocol, then the method 1500 continues at step 1545, where an error message is generated by the processor 605. Otherwise the method 200 continues at step 1550. Following step 1545, the method 1500 proceeds to step 1560 where a failure message is generated and the disconnection of the event handler objects is aborted.

At step 1550, the processor 605 performs a test to determine if both the first and second interfaces have allocated collaborator tables stored in memory 606. If both the first and second interfaces have allocated collaborator tables then the method 1500 continues at step 1565. Otherwise the method 1500 continues at step 1555, where an error message is generated. Following step 1555, the method 1500 proceeds to step 1550 where a failure message is generated and the disconnection of the event handler objects is aborted.

At step 1565, an entry is removed or changed in the collaborator table allocated to the first interface and stored in memory 606 so that the table maps the second event handler object to a null interface identifier. At the next step 1570, an entry is removed or changed in the collaborator table allocated to the second interface so that the table maps the first event handler object to a null interface identifier. At the next step 1575, a success message is generated by the processor 605 and the method 1500 concludes.

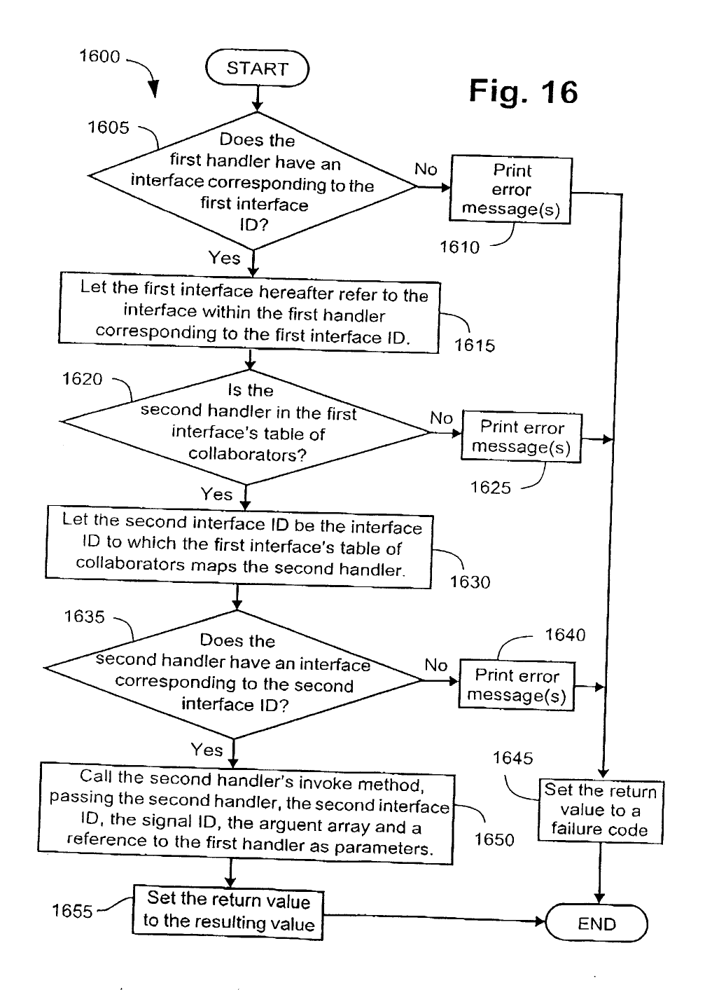

FIG. 16 is a flow diagram showing a method 1600 of sending a message from a first event handler object, which may or may not be the same as the first event handler object described above, to a single specified second event handler object which is associated with an interface of the first event handler object, in accordance with the emitsingle procedure. The method 1600 is preferably implemented using software resident on the hard disk drive 610 of the computer system 600 and is read and controlled in its execution by the processor unit 605.

The method 1600 has the following input parameters: a reference associated with a first event handler object; an interface identifier identifying the interface of the first event handler object; a message identifier; and a reference associated with an argument list. The method 1600 procedure is configured to check that the interface of the first event handler object has an entry keyed by a reference associated with a second event handler object. The method 1600 procedure is also configured to call the invoke procedure of the second event handler object and pass a reference associated with the second event handler object, a message identifier, an argument list; and a reference associated with the first event handler object, to the second event handler object.

The method 1600 begins at step 1605, where the processor 605 performs a test to determine if the first event handler object has an interface corresponding to a first predetermined interface identifier. If the first event handler object has an interface corresponding to the first predetermined interface identifier, then the method 1600 continues to the next step 1615. Otherwise, the method 1600 proceeds to step 1610, where an error message is generated by the processor 605. Following step 1610, the method 1600 proceeds to step 1645 where a failure message is generated by the processor 605 and the method 1600 concludes.

At step 1615, a first interface is set to be the interface within the first event handler object corresponding to the first interface identifier. At the next step 1620, a test is performed by the processor 605 to determine if the second event handler object has an interface corresponding to a second predetermined interface identifier. If the second event handler object has an interface corresponding to the second predetermined interface identifier, then the method 1600 continues to the next step 1630. Otherwise, the method 1600 proceeds to step 1625, where an error message is generated by the processor 605 Following step 1625, the method 1600 proceeds to step 1645 where a failure message is generated by the processor 605 and the method 1600 concludes.

At step 1630, a second interface identifier is set to be the interface identifier to which the collaborator table associated with the first event handler object, maps the second event handler object. At the next step 1635, a test is performed by the processor 605 to determine if the interfaces associated with the second event handler object use the same protocol as the first event handler object. If the interfaces associated with the second event handler object do use the same protocol as the first event handler object, then the method 300 proceeds to step 1650. Otherwise, the method 1600 proceeds to step 1640, where the processor 605 generates an error message. Following step 1640, the method 1600 proceeds to step 1645 where a failure message is generated and the method 1600 concludes.

At step 1650, the first event handler object calls an invoke procedure contained in the second event handler object and sends at least four parameters to the second event handler object. The four parameters include a message identifier, the second interface identifier, an argument array and a reference associated with the first event handler object.

At the next step 1655, a success message is generated by the processor 605 and the method 1600 concludes.

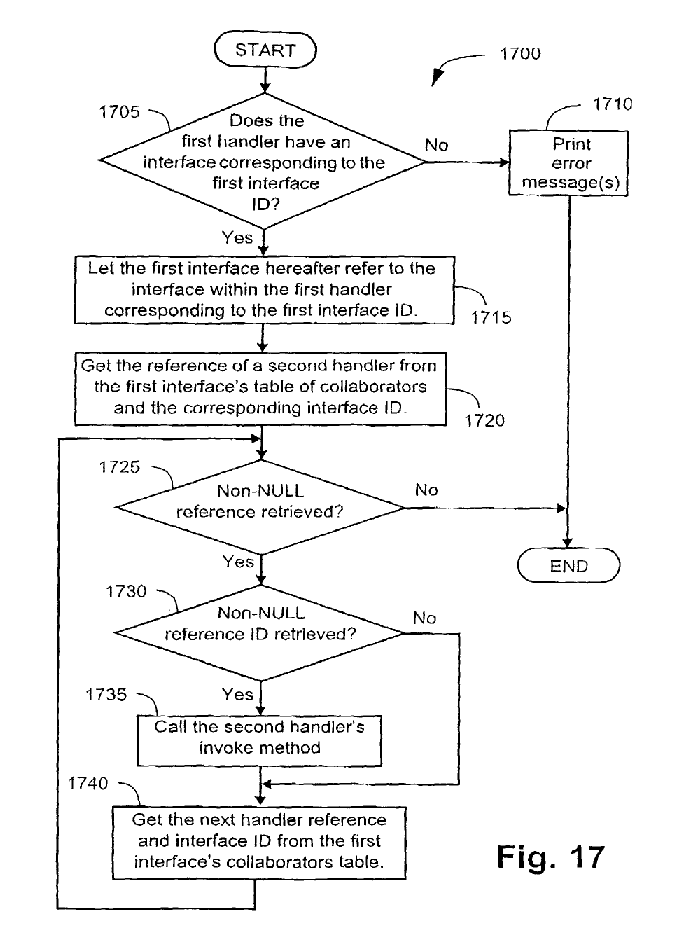

FIG. 17 is a flow diagram showing a method 1700 of sending a message from a first event handler object, which may or may not be the same as the first event handler object described above, to all event handler objects which are associated with an interface of the first event handler object. The method 1700 is preferably implemented using software resident on the hard disk drive 610 of the computer system 600 and is read and controlled in its execution by the processor unit 605.

The method 1700 has the following input parameters: a reference associated with a first event handler object; an interface identifier identifying the interface of the first event handler object; a message identifier and a reference associated with an argument list. The method 1700 is configured to determine that the interface of the first event handler object has an entry keyed by a reference associated with a second event handler object. The method 1700 is also configured to examine the collaborator table of the interface of the first event handler object stored in memory 606 and to call the invoke procedure of each event handler object included in the collaborator table. The method 1700 passes a reference associated with each of the event handler objects, a message identifier, an argument list and a reference associated with the associated object, to each of the event handler objects.

The method 1700 examines the table of collaborators stored in memory 606 and associated with the interface associated with the first event handler object to identify all event handler objects which arc associated with the interface and calls each of the invoke procedures associated with these event handler objects. The method 1700 begins at step 1705, where a test is performed by the processor 605 to determine if the first event handler object has an interface corresponding to a first predetermined interface identifier. If the first event handler object has an interface corresponding to the first predetermined interface identifier then the method 1700 continues to the next step 1715. Otherwise, the method 1700 proceeds to step 1710, where an error message is generated by the processor 605. Following step 1710, the method 1700 concludes.

At step 1715, a first interface is set to be the interface within the first event handler object corresponding to the first interface identifier. At the next step 1720, a second interface identifier is set to be the interface identifier to which the collaborator table associated with the first event handler object and stored in memory 606, maps the second event handler object. At the next step 1725, if there are no more event handler objects with entries in the collaborator table associated with the first event handler object, then the method 1700 concludes. Otherwise, the method 1700 proceeds to step 1730 where a test is performed by the processor 605 to determine if the first interface associated with the interface identifier retrieved from the collaborator table associated with the first event handler object, is non-null. If the result of step 1730 is true then the method 1700 proceeds to the next step 1735. Otherwise, the method 1700 proceeds to step 1740. At step 1735, the invoke procedure associated with the second event handler object is called and a message identifier and second interface identifier is sent to the second event handler object. At step 1740, the next event handler object reference and interface identifier is retrieved from memory 606 and the method 1700 returns to step 1725.

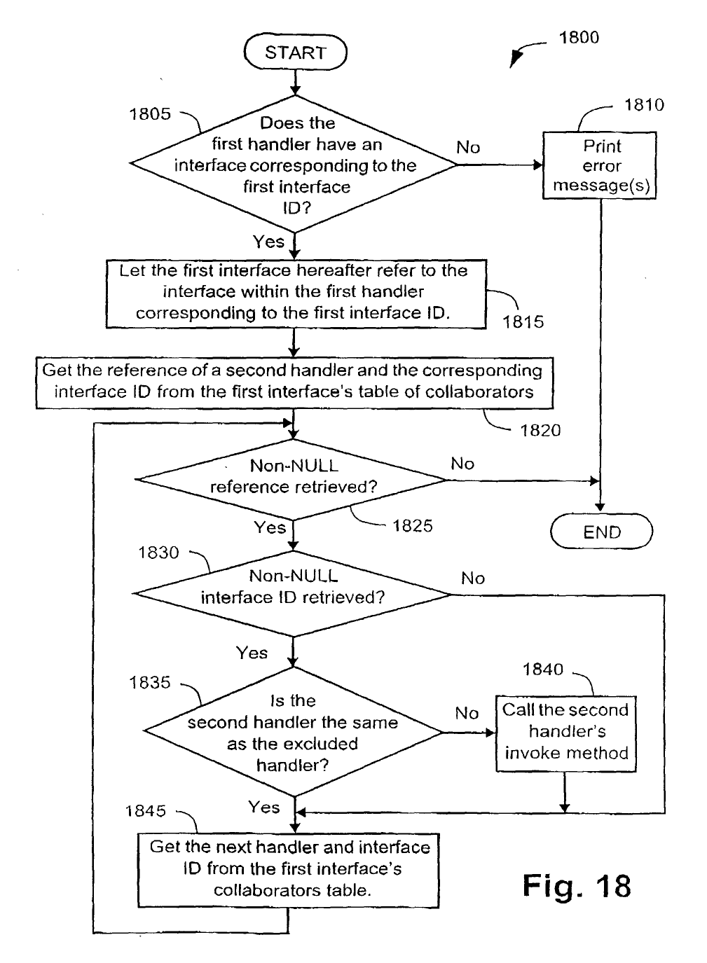

FIG. 18 is a flow diagram showing a method 1800 for sending a message from a first event handler object to all event handler objects which are associated with an interface of a first event handler object, except an event handler object which has been specifically excluded. The method 1800 is preferably implemented using software resident on the hard disk drive 610 of the computer system 600 and is read and controlled in its execution by the processor unit 605.

The method 1800 has the following input parameters: a reference associated with the first event handler object; an interface identifier identifying the interface of the first event handler object; a reference associated with a second event handler object; a message identifier and a reference associated with an argument list. The method 1800 is configured to determine that the interface of the first event handler object has an entry keyed by a reference associated with the second event handler object. The method 1800 is also configured to examine the collaborator table of the interface of the first event handler object, stored in memory 606, and to call the invoke procedure of each event handler object included in the collaborator table except for an event handler object identified by a parameter passed to the first event handler object. The method 1800 passes a reference associated with each of the event handler objects, a message identifier, an argument list and a reference associated with the first event handler object, to each of the event handler objects.

The method 1800 examines the table of collaborators for the interface to identify all event handler objects which are associated with the interface and the processor 605 calls each of the invoke procedures associated with these event handler objects, except the invoke procedure associated with the second event handler object. The method 1800 begins at step 1805, where a test is performed by the processor 605 to determine if the first event handler object has an interface corresponding to a first predetermined interface identifier. If the first event handler object has an interface corresponding to the first predetermined interface identifier then the method 1800 continues to the next step 1815. Otherwise, the method 1800 proceeds to step 1810, where the processor 605 generates an error message is generated. Following step 1810, the method 1800 concludes.

At step 1815, a first interface is set to be the interface within the first event handler object corresponding to the first interface identifier. At the next step 1820, a second interface identifier is set to be the interface identifier to which the collaborator table associated with the first event handler object, maps the second event handler object. At the next step 1825, if there are no more event handler objects with entries in the collaborator table associated with the first event handler object, then the method 1800 concludes. Otherwise, the method 1800 proceeds to step 1830 where a test is performed to determine if the first interface associated with the interface identifier retrieved from the collaborator table associated with the first event handier object, is non-null. If the result of step 1830 is true then the method 1800 proceeds to the next step 1835. Otherwise, the method 1800 proceeds to step 1845. At step 1835, a test is performed by the processor 605 to determine if the second event handler object is the excluded event handler object. If the second event handler object is the excluded event handler object then the method 1800 proceeds to step 1845. Otherwise, the method 1800 proceeds to step 1840, where the invoke procedure associated with the second event handler object is called by the processor 605 and a message identifier and second interface identifier is sent to the second event handler object. At step 1845, the next event handler object entry and interface identifier are retrieved from the collaborator table stored in memory 606 and associated with the first event handler object, and the method 1800 returns to step 1825.

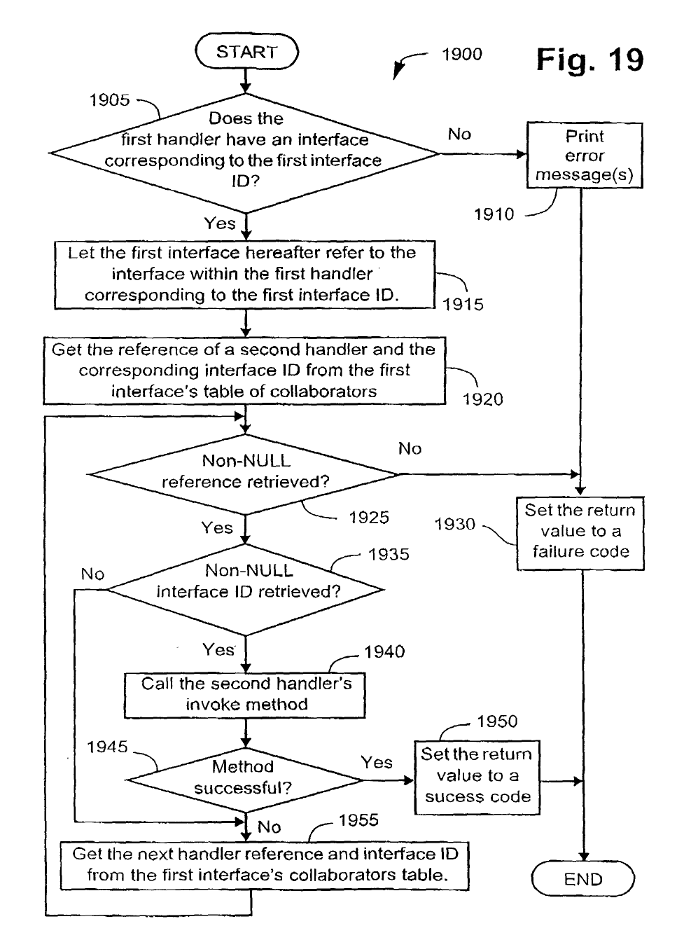

FIG. 19 is a flow diagram showing a method of sending a message from a first event handler object to all event handler objects which are associated with an interface of the first event handler object, until one of these event handler objects indicates successful completion. The method 1900 is preferably implemented using software resident on the hard disk drive 610 of the computer system 600 and is read and controlled in its execution by the processor unit 605.

The method 1900 has the following input parameters: a reference associated with the first event handler object; an interface identifier identifying the interface of the first event handler object; a message identifier and a reference associated with an argument list. The method 1900 is configured to check that the interface of the first event handler object has an entry keyed by a reference associated with a second event handler object. The method 1900 is also configured to examine the collaborator table of the interface of the first event handler object and to call the invoke procedure of each event handler object included in the collaborator table. The method 1900 passes a reference associated with the other event handler object, a message identifier, an argument list and a reference associated with the first event handler object, to each of the event handler objects until one of the event handler objects receives a success code.

The method 1900 begins at step 1905, where a test is performed by the processor 605 to determine if the first event handler object has an interface corresponding to a first predetermined interface identifier. If the first event handler object has an interface corresponding to the first predetermined interface identifier then the method 1900 continues to the next step 1915. Otherwise, the method 1900 proceeds to step 1910, where an error message is generated by the processor 605. Following step 1910, the method 1900 proceeds to step 1930 where a failure message is generated and the method 1900 concludes.

At step 1915, a first interface is set to be the interface within the first event handler object corresponding to the first interface identifier. At the next step 1920, a second interface identifier is set to be the interface identifier to which the collaborator table associated with the first event handler object, maps the second event handler object. At the next step 1925, if there are no more event handler objects with entries in the collaborator table associated with the first event handler object, then the method 1900 proceeds to step 1930 where a failure message is generated and the method 1900 concludes. Otherwise, the method 1900 proceeds to step 1935 where a test is performed by the processor 605 to determine if the first interface associated with the interface identifier retrieved from the collaborator table stored in memory 605 and being associated with the first event handler object, is non-null. If the result of step 1935 is true then the method 1900 proceeds to the next step 1940. Otherwise, the method 1900 proceeds to step 1955. At step 1940, the invoke procedure associated with the second event handler object is called by the processor 605 and a message identifier and second interface identifier is sent to the second event handler object. At the next step 1945, if the call at step 1940 is successful then the method 1900 proceeds to step 1950 where a success message is generated and the method 1900 concludes. Otherwise, the method 1900 proceeds to step 1955 where the next event handler object reference and interface identifier are retrieved from the collaborator table associated with the first event handler object and the method 1900 returns to step 1925.

The invoke procedure of the associated object has the following input parameters: a reference associated with a first event handler object; an interface identifier identifying the interface of the first event handler object; a message identifier and a reference associated with an argument list. The invoke procedure is configured to select a course of action (eg. activating a procedure, calculating a data value, determining the meaning of a key-board press, or the like) depending on the interface identifier and message identifier of the receiving interface. The invoke procedure can also be configured to change data fields associated with an event handler object. A base class invoke procedure from which all other invoke procedures are inherited is configured to check, that the interface of the associated event handler object has an entry keyed by a reference associated with the other event handler object and to check that the side identifier of the interface of the associated event handler object represents a valid side of the protocol used by the event handler object. The base class invoke procedure is also configured to check that the message identifier represents a message that is emitted by event handler objects conforming to the other side of the protocol, and to return a success code or a failure code depending on the result of this check.

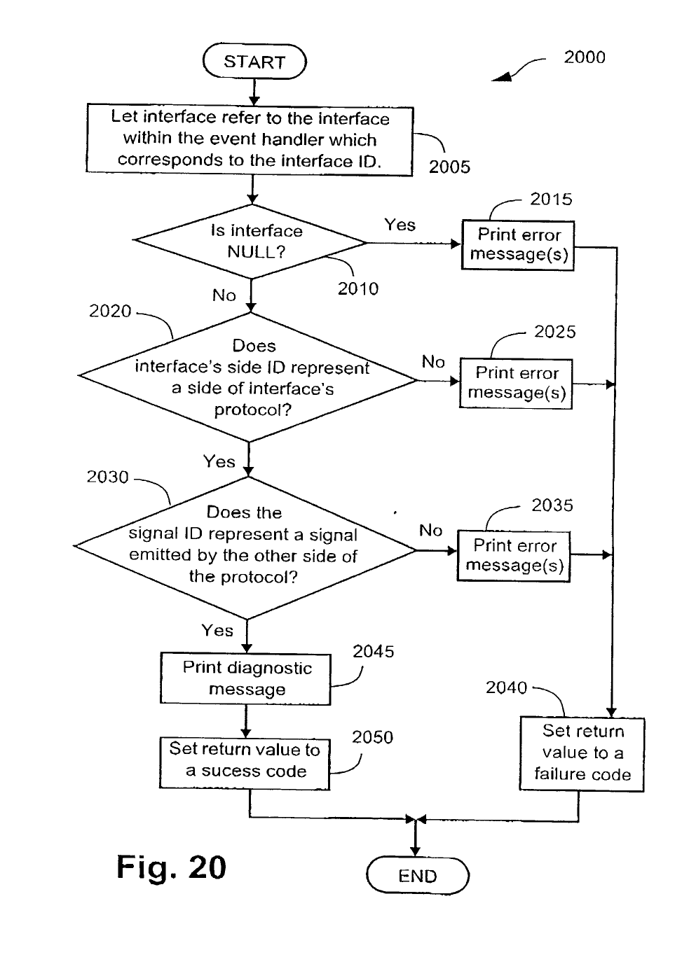

FIG. 20 is a flow diagram showing a method 2000 of receiving a message from an first event handler object. As described above, the message includes a message identifier. The method 2000 is preferably implemented using software resident on the hard disk drive 610 of the computer system 600 and is read and controlled in its execution by the processor unit 605. The method 2000 is used by the base event handler object class (ie. the object class from which all of the event handler objects within the class are derived). The method 2000 begins at step 2005, where a first predetermined interface is set to be the interface within the first event handler object corresponding to the first interface identifier. At the next step 2010, a test is performed by the processor 605 to determine if the first interface is null. If the first interface is not null, then the method 2000 proceeds to step 2020. Otherwise, the method 2000 proceeds to step 2015, where an error message is generated by the processor 605. Following step 2015, the method 2000 proceeds to step 2040 where a failure message is generated and the method 2000 concludes.

At step 2020, a test is performed by the processor 605 to determine if the side of the protocol represented by the first interface identifier is valid. In this instance, the side of the protocol is considered to be valid if the side is identified as a ‘receive’ side of the protocol. If the first interface is not identified with a valid side of the protocol, then the method 2000 proceeds to step 2030. Otherwise, the method 2000 proceeds to step 2025, where the processor 605 generates an error message. Following step 2025, the method 2000 proceeds to step 2040 where a failure message is generated and the method 2000 concludes.

At step 2030, a test is performed by the processor 605 to determine if the side of the protocol represented by the message identifier is valid. In this instance, the side of the protocol identified by the message identifier is considered to be valid if the side is identified as a ‘send’ side of the protocol. If the message identifier does not identify a valid side of the protocol, then the method 2000 proceeds to step 2040. Otherwise, the method 2000 proceeds to step 2035, where an error message is generated by the processor 605 Following step 2035, the method 2000 proceeds to step 2040 where a failure message is generated and the method 2000 concludes.

At the next step 2045, a diagnostic message is generated. The diagnostic message indicates that the side of the message protocol represented by the message identifier is valid. The diagnostic message call also record the values of the receiving and sending event handler objects at the time that the message was received. At the next step 2050, a success message is generated and the method 2000 concludes.

As described above, objects that deal with keyboard focus are generally referred to as focus event handler objects and belong to the focus event handler object class which provides an abstract base class for functionality that is common to all focus event handler objects within the focus event handler object class. One such characteristic is that almost all focus event handler objects transfer focus between sibling focus event handler objects, via a focus transferral protocol.

The focus event handler object class inherits all of the functionality of the event handler object class.

The interfaces of the focus event handler object class, in accordance with the methods described herein, are as follows:

“fh_giver”: This represents one side of the focus transferral (ie. the sender side) protocol that is used; and

“fh_taker”. This represents one side of the focus transferral (ie. the receiver side) protocol that is used.

The invoke procedure associated with each of the focus event handler objects is configured to call the invoke procedure of the base event handler object class, passing on any arguments associated with the focus event handler object. The focus event handler object class is preferably not directly instantiated.

Drop down menus, which are well known in the art, are generally associated with a graphical user interface and can respond to keyboard events. Such menus generally have an active (ie. focused) component and several inactive components. Therefore, in the methods described herein, a menu item event handler object class and a menu screen event handler object class can be used to represent individual screens of a graphical user interface system comprising one or more graphical object components, and a containing screen which indicates the screen that is currently visible. Menu item event handler objects and menu screen event handler objects can communicate according to the menu item control (“receiver”) protocol described above.

The menu item event handler object class and the menu screen event handler object class both inherit all of the functionality of the focus event handler object class. The menu item event handler object class and the menu screen event handler object class include an interface referred to as “mih_parent”, which complies with the menu item control (“receiver”) protocol. The menu item event handler object class and the menu screen event handler object class also have extra data fields over the event handler object class. The extra data fields are as follows:

mih_siblings: This represents a table that can be included within event handler objects to represent event handler objects that can be given the focus; and

mih_ns: This represents a namespace which can be included within event handler objects. A menu item event handler object can change the state of this namespace.

The menu item event handler object class and the menu screen event handler object class include a procedure referred to as connect_sibling. The connect_sibling procedure identifies two menu item event handler objects (ie. a first and second focus event handier object) for use in the focus transfer and the associated side identifiers identifying the desired focus transfer protocol between the two menu item event handler objects. The first and second focus event handler objects communicate according to the focus transfer protocol. If the side identifier specifying the position of the second focus event handler object relative to the first focus event handler object is non-NULL, then the sibling table (ie. mih_siblings) of the first focus event handler object is changed so that the side identifier associated with the first focus event handler object maps to the second focus event handler object. In this manner, the interface “fh_giver” for the first focus event handler object is connected to the interface “fh_taker” for the second focus event handler object. In a similar manner, if the side identifier specifying the position of the first focus event handler object relative to the second focus event handler object is non-NULL, then the sibling table (ie. mih_siblings) of the second focus event handler object is changed so that the side identifier associated with the second focus event handler object maps to the first focus event handler object. In this manner, the interface “fh_giver” for the second focus event handler object is connected to the interface “fh_taker” for the first focus event handler object. The invoke procedure corresponding to each of the first and second focus event handler objects checks the interface identifier for each signal received by the respective event handler object, to determine that the interface identifiers are “mih_parent” or “fh_taker”.

A receiving menu item event handler object determines if the received interface identifier is “mih_parent”. The invoke procedure of the receiving menu item event handler object checks the message identifier that was passed. If the message identifier is one of “left”, “up”, “right” or “down”, then the sibling table associated with the receiving menu item event handler object is queried to find the event handler object corresponding to the signal identifier. If there is a corresponding event handler object then the emitsingle procedure is called with a reference associated with the receiving event handler object, an “fh_giver” interface identifier, the sibling event handler object of the receiving event handler object, a “set_focus” message identifier and an array containing one extra argument. The extra argument is the original message identifier (“left”, etc). If the message identifier is “action”, then the animated state machine namespace of the menu item event handler object executes a loop method and the parent object of the menu item event handler object is sent a “pressed” signal. If the signal identifier is “set_visibility”, then the animated state machine namespace of the menu item event handler object executes a goto_state procedure.

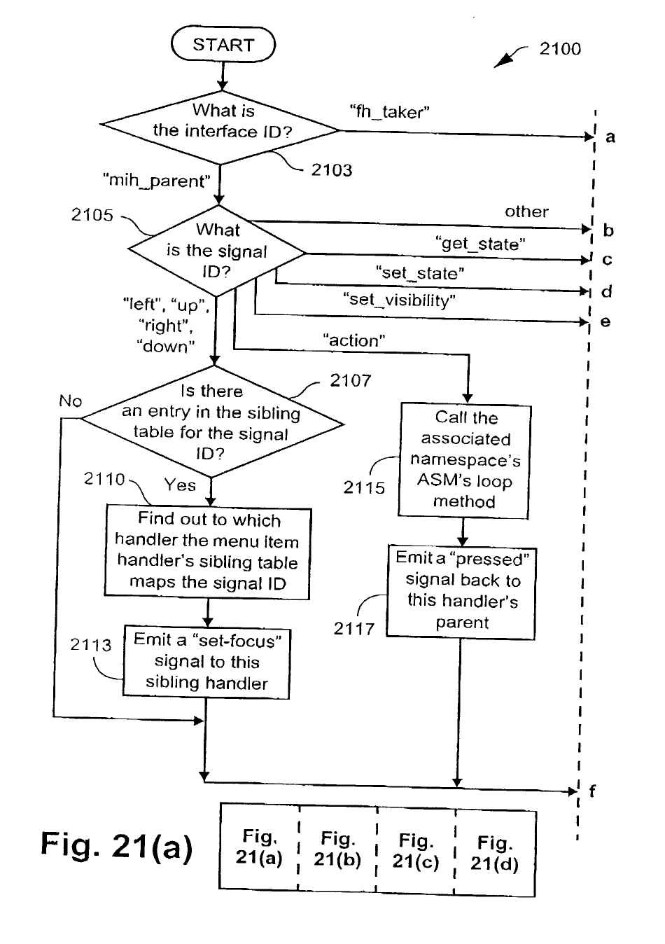

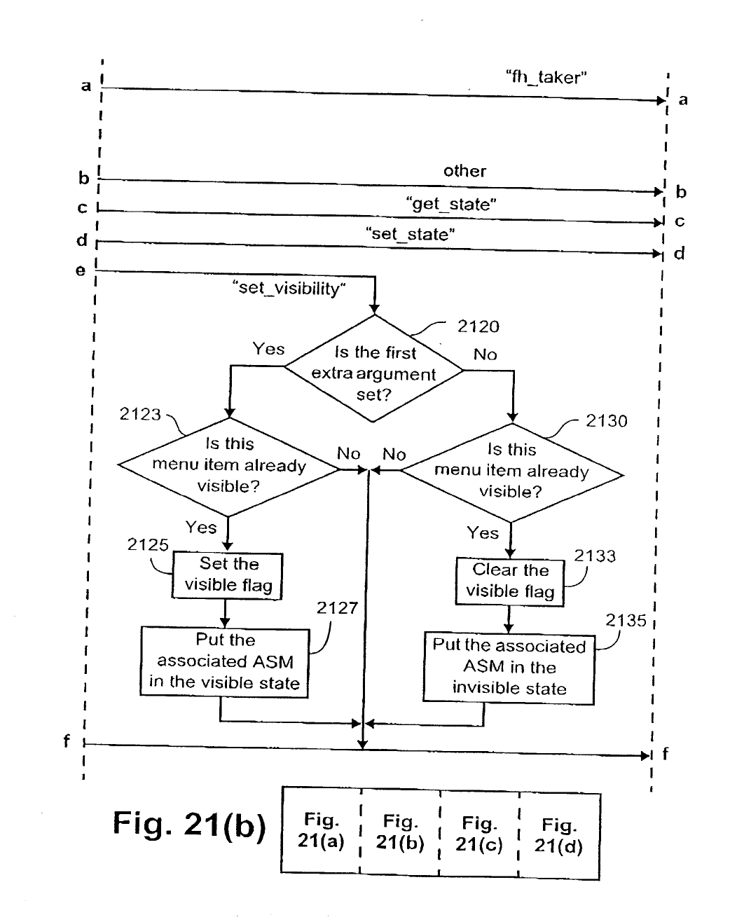

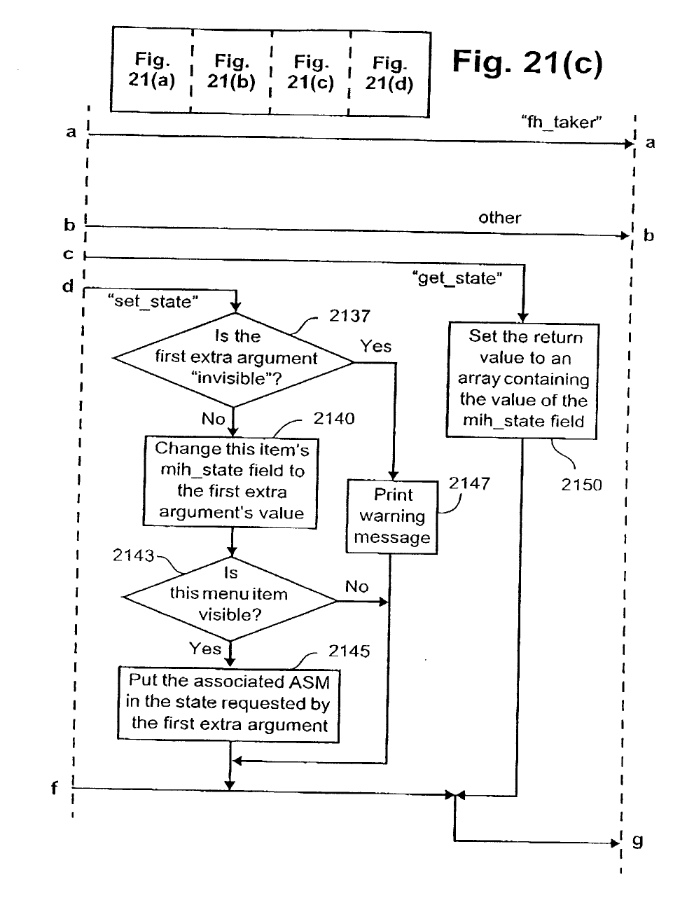

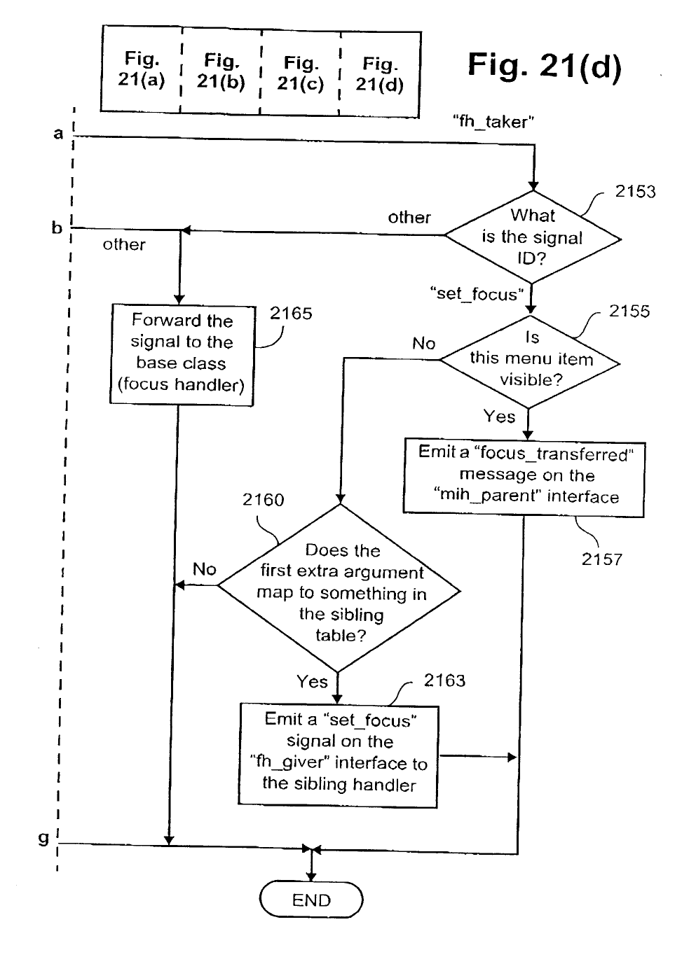

FIG. 21 is a flow diagram showing a method 2100 of receiving a message from a first menu item event handler object (ie. a sending object). The message includes a message identifier and an interface identifier. The method 2100 is used by both the menu item event handler object class and the menu screen event handler object class. The method 2100 is preferably implemented using software resident on the hard disk drive 610 of the computer system 600 and is read and controlled in its execution by the processor unit 605. The method 2100 begins at the first step 2103, where the interface identifier associated with the message, sent to a first menu item event handler object, is examined by the second event handle object (ie. the receiving menu item event handler object). If the interface identifier is “mih_parent”, indicating that the menu item_control (“receiver”) protocol is being used by the sending menu item event handler object, then the method 2100 proceeds to step 2105. Otherwise, the method 2100 proceeds to step 2153.

At step 2105, the method 2100 continues depending on one of nine alternatives determined by the processor 605 for the message identifier.

If the message identifier is one of “left”, “up”, “right”, or “down”, then the method 2100 continues at the next step 2107.

If the message identifier is “action”, at step 2107, then the method 2100 continues at the step 2115.

If the message identifier is “set_visibility”, at step 2107, then the method 2100 continues at the step 2120.

If the message identifier is “set_state”, at step 2107, then the method 2100 continues at the step 2137.

If the message identifier is “get_state”, at step 2107, then the method 2100 continues at the step 2150.

Otherwise, the method 2100 proceeds to step 2165.

At step 2107, if there is an entry in the sibling table stored in memory 606 for the receiving menu item event handler object, for the message identifier (ie. “left”, “up”, “right”, or “down”), then the method 2100 proceeds to step 2110. Otherwise, the method 2100 concludes. At step 2110, the sibling table is examined by the processor 605 in order to determine to which associated menu item event handler object the signal identifier has been mapped. At the next step 2113, a “set_focus” message is transmitted by the receiving menu item event handler object to a sibling menu item event handler object of the receiving menu item event handler object and the method 2100 concludes.

At step 2115, loop procedures are called, by the receiving menu item event handler object, for any graphical objects associated with the menu item event handler object. At the next step 2117, a “pressed” signal is transmitted by the processor 605 from the receiving menu item event handler object to a parent menu item event handler object, and the method 2100 concludes.

At step 2120, a first extra argument passed from the invoke procedure of the sending menu item event handler object is read by the processor 605 as a Boolean flag to determine if the flag is set. If the flag is set then the method 2100 proceeds to step 2123. Otherwise, the method 2100 proceeds to step 2130. At step 2123, if the visible flag of the receiving menu item event handler object is set, then the method 2100 concludes. The visible flag indicates that any graphical objects associated with the receiving menu item event handler object is visible on the display screen of the host graphical user interface. Otherwise, the method 2100 proceeds to step 2125, where the visible flag of the receiving menu item event handler object is set. At the next step 2127, the graphics associated with the receiving menu item event handler object are made visible on the screen (eg. the display 614) of the host graphical user interface and the method 2100 concludes.

At step 2130, if the visible flag of the receiving menu item event handler object is clear then the method 2100 concludes. Otherwise, the method 2100 proceeds to step 2133, where the visible flag of the receiving menu item event handler object is cleared by the processor 605. At the next step 2135, the graphics associated with the receiving menu item event handler object are made visible on the screen of the host graphical user interface and the method 2100 concludes.

At step 2137, the first extra argument passed by the invoke procedure of the sending menu item event handler object is read to determine if the first extra argument is invisible. If the result of step 2137 is true then the method 2100 proceeds to step 2147 where a print message is generated and the process concludes. Otherwise, the method 2100 proceeds to step 2140 where the “mih_State” field of the receiving menu item event handler object is changed to the value of the first extra argument. At the next step 2143, if the graphic objects associated with the receiving menu item event handler object are visible then the method 2100 proceeds to step 2145. Otherwise, the method 2100 concludes. At step 2145, the graphic objects associated with the receiving menu item event handler object are set to the state requested by the first extra argument.

At step 2150, a value set to the resultant of an array stored in memory 606 and containing the value of “mih_State” field is returned to the sending menu item event handler object.

At step 2153, if the message identifier is “set_focus”, then the method 2100 proceeds to step 2155. Otherwise, the method 2100 proceeds to step 2165. At step 2155, if the graphic objects associated with the receiving menu item event handler object are visible then the method 2100 proceeds to step 2157. Otherwise, the method 2100 proceeds to step 2160. At step 2157, a “focus_transferred” message is generated by the menu item event handler object utilising the “mih_parent” interface and the method 2100 concludes.

At step 2160, if the sibling table of the receiving menu item event handler object maps the first extra argument to another event handler object then the method 2100 proceeds to step 2163. Otherwise, the method 2100 concludes. At step 2163, a “set_focus” message is generated by the receiving menu item event handler object using the “fh_giver” interface, and the set_focus message is sent to the event handler object of the sibling. Following step 2163, the method 2100 concludes.

At step 2165, the invoke procedure of the focus event handler object is called by the invoke procedure of a base event handler object and the method 2100 concludes.

A graphical user interface for an application program is often composed of several different screens which can be which can be displayed at any one time on a display device such as the display device 614. Each of the screens can have a set of related graphical object components such that a currently visible screen has an active (ie. focused) component. Therefore, in the methods described herein, a menu screen event handler object class is used to represent the containing screen.

The menu screen event handler object class inherits all of the functionality of the focus event handler object class described above. Menu screen event handler objects of the menu screen event handler object class can communicate with menu item event handler objects according to the menu screen control protocol.

The menu screen event handler object class includes the following interfaces:

“mh_parent”: This represents the receiver side of the menu control (“receiver”) protocol; and

“mh_child”: This represents the sender side of the menu item control (“sender”) protocol.

The menu screen event handler object class comprises extra data fields over the focus event handler object class described above, as follows:

mh_siblings: This represents a table which is included within a menu screen event handler object listing all event handler objects that can be given the focus; and

mh_ns: This represents a namespace which can be included within menu screen event handler objects. A menu screen event handler object can change the state of this namespace; and

mh_focused: This field records which child menu item event handler objects should be given keyboard events.

The menu screen event handler object class is configured with an extra procedure referred to as connect_sibling. The connect_sibling procedure is configured to change the entries in the sibling table of a first menu screen event handler object so that the sibling table maps the first menu screen event handler object to a second menu screen event handler object.

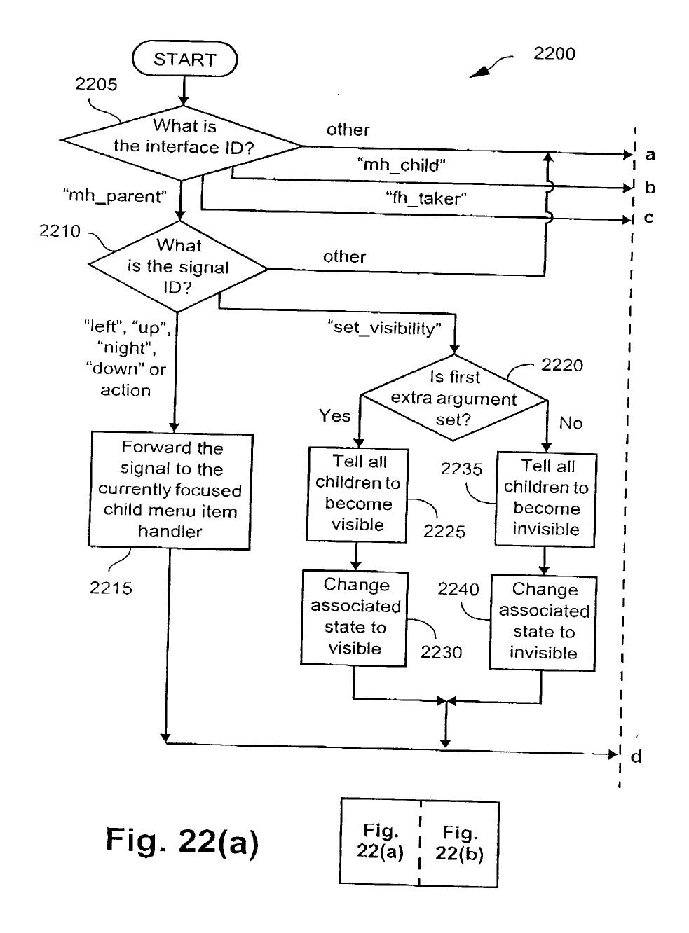

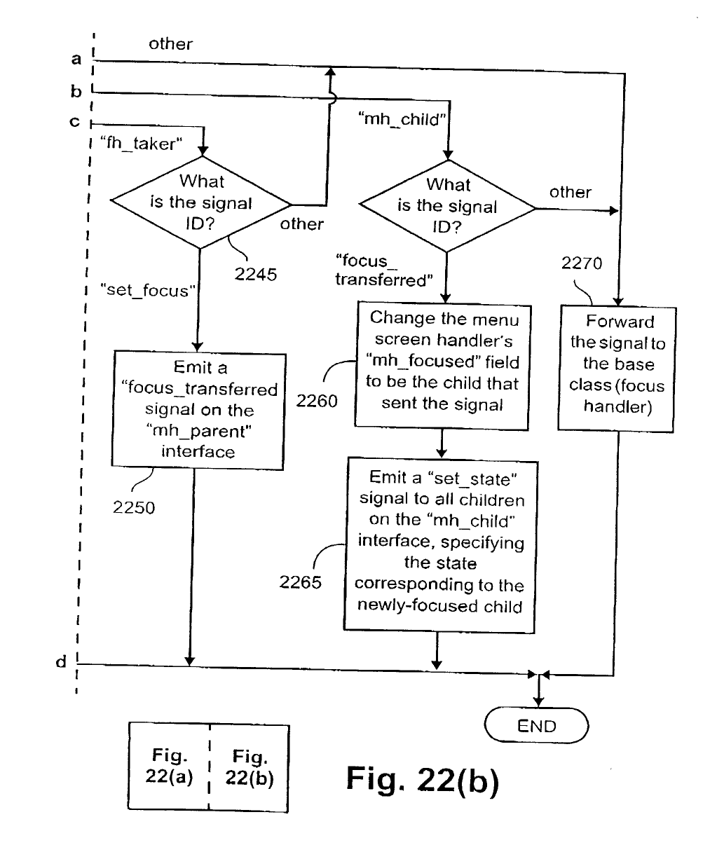

The invoke procedure of the first menu screen event handler object examines each received message and if the message identifier is one of “mh_parent”, “fh_taker”, or “mh_child”, then the connect_sibling procedure is activated. FIG. 22 is a flow diagram showing a method 2200 of receiving a message from a first menu screen event handler object (ie. a sending object). As described above, the message includes a message identifier and an interface identifier. The method 2200 is used by the menu screen event handler object class. The method 2200 begins at the first step 2205, where the interface identifier, associated with the message sent to a second menu screen event handler object (ie. the receiving event handler object), is examined by the receiving menu screen event handler object. If the interface identifier is “mh_parent”, indicating that the menu control (“receiver”) protocol is being used by the sending menu screen event handler object, then the method 2200 proceeds to step 2210.

At step 2210, the method 2200 continues depending on one of six alternatives for the message identifier.

If the message identifier is one of “left”, “up”, “right”, or “down”, then the method 2200 continues at the next step 2215.

If the message identifier is “set_visibility”, at step 2210, then the method 2200 continues at the step 2220.

Otherwise, the method 2200 proceeds to step 2270.

At step 2215, the message is retransmitted by the receiving menu screen event handler object to the child menu item event handler object that currently has focus.

At step 2220, a first extra argument passed from the invoke procedure of the sending menu screen event handler object is read as a flag to determine if the flag is set. If the flag is set then the method 2200 proceeds to step 2225. Otherwise, the method 2200 proceeds to step 2235. At step 2225, the receiving menu screen event handler object transmits a “set_visibility” message to all child menu item event handler objects, passing a set argument to each of the child menu item event handler objects. At the next step 2230, all graphical objects associated with each of the child menu item event handler objects become visible on the host graphical user interface.

At step 2235, the receiving menu screen event handler object transmits a “set_visibility” message to all child menu item event handler objects, passing a cleared argument to each of the child menu item event handler objects. At the next step 2240, all graphical objects associated with each of the child menu item event handler objects become invisible on the host graphical user interface.

At step 2270, the invoke procedure of the focus event handler object is called by the invoke procedure of a base event handler object and the method 2200 concludes.

At step 2205, if the interface identifier is “fh_taker”, indicating that the focus transferral (“receiver”) protocol is being used by the sending menu screen event handler object, then the method 2200 proceeds to step 2245. At step 2245, if the message identifier is “set_focus” then the method 2200 proceeds to step 2250. Otherwise, the method 2200 proceeds to step 2270 as discussed above. At step 2250, a “focus_transferred” message is generated by the sending menu screen event handler object utilising the “mh_parent” interface and the method 2200 concludes.

At step 2205, if the interface identifier is “mh_child”, indicating that the menu item control (“sender”) protocol is being used by the sending menu screen event handler object, then the method 2200 proceeds to step 2255. At step 2255, if the message identifier is “focus_transferred” then the method 2200 proceeds to step 2260. Otherwise, the method 2200 proceeds to step 2270 as discussed above. At step 2260, a “mh_focused” field of the menu screen event handler object is changed to reference the child menu item event handler object that was responsible for the signal. At the next step 2265, the receiving menu screen event handler object transmits a “set_state” message to all child menu screen event handler objects using the “mh_child” interface to specify the state corresponding to the currently focused child menu screen event handler object that has keyboard focus. After step 2265, the method 2200 concludes.

A further event handler object class utilised in the methods described herein is referred to as the menu switch handler object class. The menu switch handler object class inherits all of the functionality of the event handler object class. The menu switch handler object class can communicate with the menu switch event handler object class using the keyboardraw protocol referred to above. The interfaces of the menu switch handler object class are as follows:

msh_raw_input: This represents a message which complies with the receiver side of the key board raw (“receiver”) protocol; and

mh_child: This represents a message which complies with the sender side of the menu control (“sender”) protocol.

The menu switch event handler object class includes a field, “msh_focused”, which contains a reference associated with the menu item event handler object that currently has the focus (ie. the object that is sent keyboard events by the menu switch handler). A menu switch handler object and a corresponding interface identifier are connected to the “msh_child” interface by the menu control protocol. The invoke procedure of a menu switch handler object examines the interface identifier for each message received.

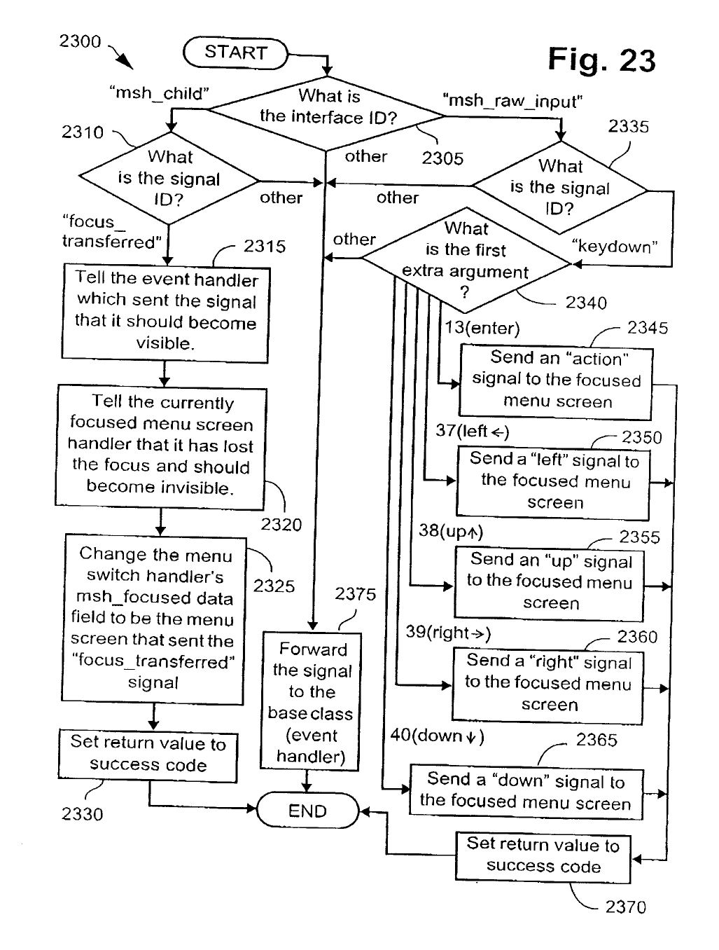

FIG. 23 is a flow diagram showing a method 2300 of receiving a message from a first menu switch event handler object (ie. a sending object). As described above, the message includes a message identifier and an interface identifier. The method 2300 is used by the menu switch event handler object class. The method 2300 begins at the first step 2305, where the interface identifier associated with the message, sent to a second menu switch event handler object (ie. the receiving event handler object), is examined by the second menu switch event handler object. If the interface identifier is “mh_child”, indicating that the menu control (“receiver”) protocol is being used by the sending menu switch event handler object, then the method 2300 proceeds to step 2310. At step 2310, if the message identifier is “focus_transferred” then the method 2300 proceeds to step 2315. At step 2315, the receiving menu switch event handler object transmits a “set_visibility” message to the associated menu switch event handler object which sent the message, passing a set argument to the menu switch event handler object. At the next step 2320, the receiving menu switch event handler object transmits a “set_visibility” message to the menu switch event handler object that currently has keyboard focus, passing a cleared argument to the menu switch event handler object. The cleared argument indicates that the menu switch event handler object having focus has lost the focus and is to become invisible. At the next step 2325, the “mh_focused” field of the menu switch event handler object is changed to reference the menu screen event handler object that was responsible for sending the message. At the next step 2330, a success code is generated by the processor 605 and the method 2300 concludes.

At step 2375, the invoke procedure of the event handler object is called by the invoke procedure of a base event handler object and the message is forwarded to the base event handler object. After step 2375, the method 2300 concludes.

If the interface identifier is “msh_raw_input”, at step 2305, indicating that the key board raw (“receiver”) protocol is being used by the sending menu switch event handler object, then the method 2300 proceeds to step 2335. At step 2335, if the message identifier is “keydown”, indicating that a key has been pressed, then the method 2300 proceeds to step 2340. Otherwise, the method 2300 proceeds to step 2375 as described above.

At step 2340, the method 2300 continues depending on one of at least six alternatives for the first extra argument of the message.

If the first extra argument sent with the message is not one of “13” or “37-40”, at step 2340, then the method 2300 proceeds to step 2375 as described above.

If the first extra argument represents the enter key (ie. generally “13”) pressed on the keyboard 602 of the computer system 600, for example, at step 2340, then the method 2300 proceeds to step 2345, where an “action” message is sent to the menu screen having focus. The action message results in a change in the menu screen, for example, a graphical object of an application may change from visible to invisible or vice versa, or a currently visible screen may become invisible as another screen becomes visible. At the next step 2370, a success message is generated by the processor 605 and the process concludes.

If the first extra argument represents the left arrow key (ie. generally 37) on the keyboard 602 of the computer system 600, for example, at step 2340, then the method 2300 proceeds to step 2350, where a “left” message is sent to the menu screen having focus. The left message results in the menu screen event handler object associated with the currently visible menu screen, passing the message down to a currently focused menu item event handler object. At the next step 2370, a success message is generated by the processor 605 and the process concludes.

If the first extra argument represents the up arrow key (ie. generally 38) on the keyboard 602 of the computer system 600, at step 2340, then the method 2300 proceeds to step 2355, where an “up” message is sent to the menu screen having focus. The up message results in the menu screen event handler object associated with the currently visible menu screen, passing the message down to a currently focused menu item event handler object. At the next step 2370 a success message is generated and the process concludes.

If the first extra argument represents the right arrow key (ie. generally 39) on the keyboard 602 of the computer system 600, at step 2340, then the method 2300 proceeds to step 2360, where a “right” message is sent by the processor 605 to the menu screen having focus. The up message results in the menu screen event handler object associated with the currently visible menu screen, passing the message down to a currently focused menu item event handler object. At the next step 2370 a success message is generated by the processor 605 and the process concludes.

If the first extra argument represents the down arrow key (ie. generally 40) on the keyboard 602 of the computer system, at step 2340, then the method 2300 proceeds to step 2365, where a “down” message is sent to the menu screen having focus. At the next step 2370 a success message is generated and the process concludes.

As described above, when an animated state machine is formed by a designer, one of the states of the animated state machine is defined to be the initial state. The visual appearance of a control is set to be the appearance defined at the initial state which becomes the source state. When a user interacts with the control, there is generally a change in the visual appearance of the control with the new visual appearance being represented by one of the states of the animated state machine. Therefore, the control can be configured to request the state change from the source state to a desired destination state. Such a control can also be configured to change state from a current state to a new state via one or more “waystates”, where each of the waystates represents a visual appearance of the control at a corresponding transitional point on a transition between the current state and the new state. The use of waystates in the animated state machine enables a designer to define animations utilising multiple routes for moving between two or more states and are therefore not subject to the inherent limitations of a finite state machine (ie. limited to a finite number of states). Such animations are particularly useful for defining controls that can be translated, rotated, scaled, or deformed in various ways, without restricting the control to a finite number of possible resting states.

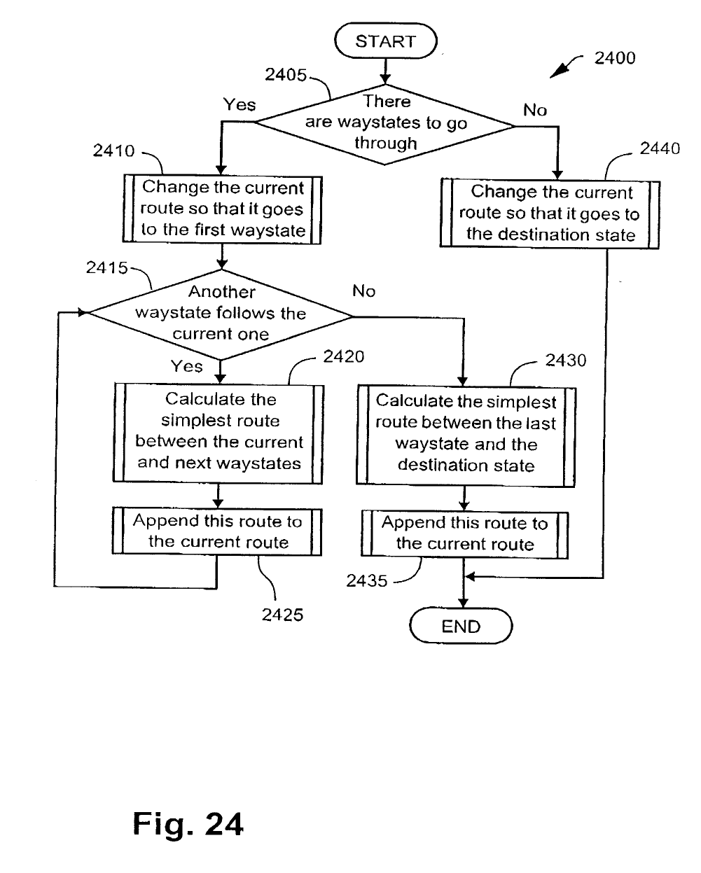

FIG. 24 is a flow chart showing a further method 2400 of determining a route to a new destination state for an animation state machine associated with a control of a graphical user interface. In contrast to the method 200, the method 2400 determines the route for the animated state machine based on zero or more waystates, as described above. The method 2400 determines the route to a next waystate based on the least number of transitions required to reach the next waystate. The method 2400 is preferably resident on the hard disk drive 610 of the computer system 600 and is read and controlled in its execution by the processor 605. The method begins at step 2405, where if the processor 605 determines that there are waystates for the animated state machine to traverse then the method 2400 proceeds to step 2410. Otherwise, the method 2400 proceeds to step 2440 where the route to the new destination state is determined for the animated state machine, according to the steps of the method 200. At step 2410, the route to the first waystate is determined for the animated state machine. The route is determined at step 2410 using the method 200 where the source state is the current state and the destination state is the first waystate. At the next step 2415, if the processor 605 determines that there are more waystates required to be traversed by the animated state machine then the method 2400 proceeds to step 2420. Otherwise, the method 2400 proceeds to step 2430. At step 2420, the processor 605 determines the least number of state transitions between the current state of a currently animating route and the first waystate for the control using the method 100. The method 2400 continues at the next step 2425, where the route determined at step 2420 is appended to a current route for the control and the method 2400 returns to step 2415.

At step 2430, a route between the last waystate and the destination state is determined using the method 100. The method 2400 continues at the next step 2435, where the route determined at step 2430 is appended to the current route for the control and the method 2400 concludes.

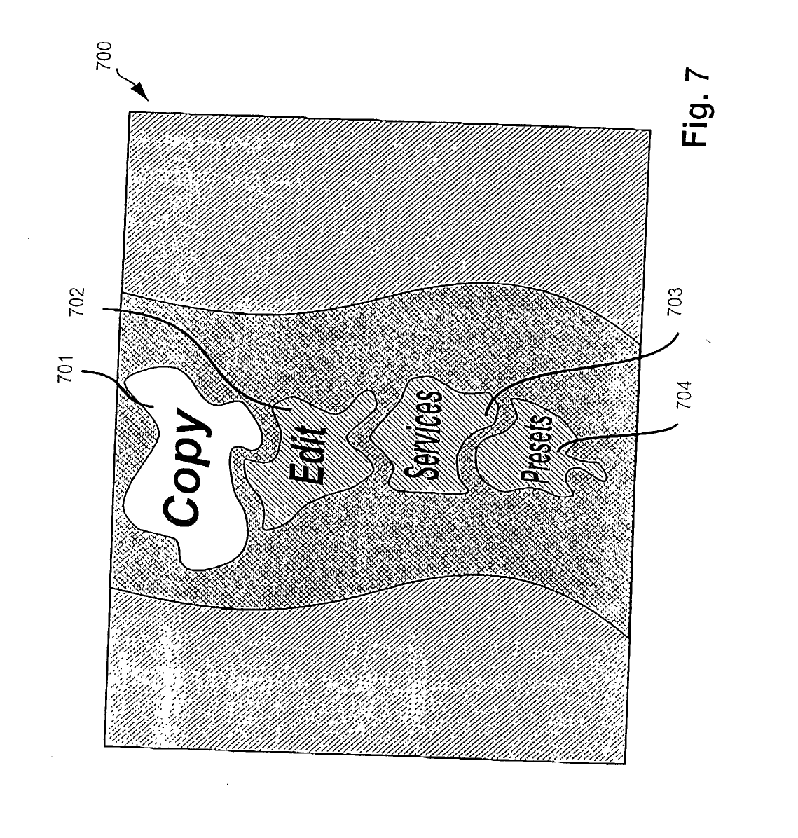

The methods described with reference to FIGS. 1 to 5 and FIGS. 14 to 24, can be implemented as part of an application program executing in conjunction with a host graphical user interface system. An example of such an application program will now be described with reference to FIGS. 7 to 13. The example application program is configured as a digital image editing and production application program. The preferred host graphical user interface, for such an application program, is the Microsoft™ Windows graphical user interface where the main window of the graphical user interface is a Microsoft™ Windows application program. The example application program uses a number of event handler objects which will be explained in detail in the following paragraphs. The example application program is preferably implemented using software resident on the hard disk drive 610 of the computer system 600 and is read and controlled in its execution by the processor unit 605. When the application program receives an input message from the keyboard 602, for example, the application program is configured to call a key_down procedure. Subsequently, the key_down procedure calls the invoke procedure of a highest-level menu switch event handler object, passing the character code corresponding to the depressed key. The invoke procedure is a procedure associated with a particular object and is configured to call another object when the particular object wishes to communicate with that other object. The invoke procedure of an object includes an array of argument values to be passed to the invoke procedure of another object, and an identifier representing the object whose class which inherits the procedure. The menu switch event handler object decides to which menu screen event handler object the message should be forwarded. The menu screen event handler object distinguishes between requests for the keyboard focus to be changed and requests for action to which a menu item event handler object with focus (ie. accepting all input from the keyboard 602) should respond.

The example application program includes a number of different screens 700, 800, 900, 1000, 1100 and 1200, as will be described below with reference to FIGS. 7 to 12 These screens can be displayed on the display device 614 of the computer system 600. In accordance with the methods described herein, each of the screens 700, 800, 900, 1000, 1100 and 1200, has an associated screen event handler object and each of the screen event handler objects is an instance of a class derived from a base menu screen event handler object.

FIG. 7 shows a menu screen 700 with four menu items 701, 702, 703 and 704, where each of the four items 701 to 704 is rendered on the display 614 using a number of graphical object components in a conventional manner. As will be explained below, each of the four items 701 to 704, has an associated screen 700, 800, 900 and 1000 shown in FIGS. 7, 8, 9 and 10, respectively, when the respective item is active (ie. the graphical object components associated with the item are visible and the item has the focus). Further, each of these menu items 701 to 704 responds to an action request by changing which menu screen has the focus.

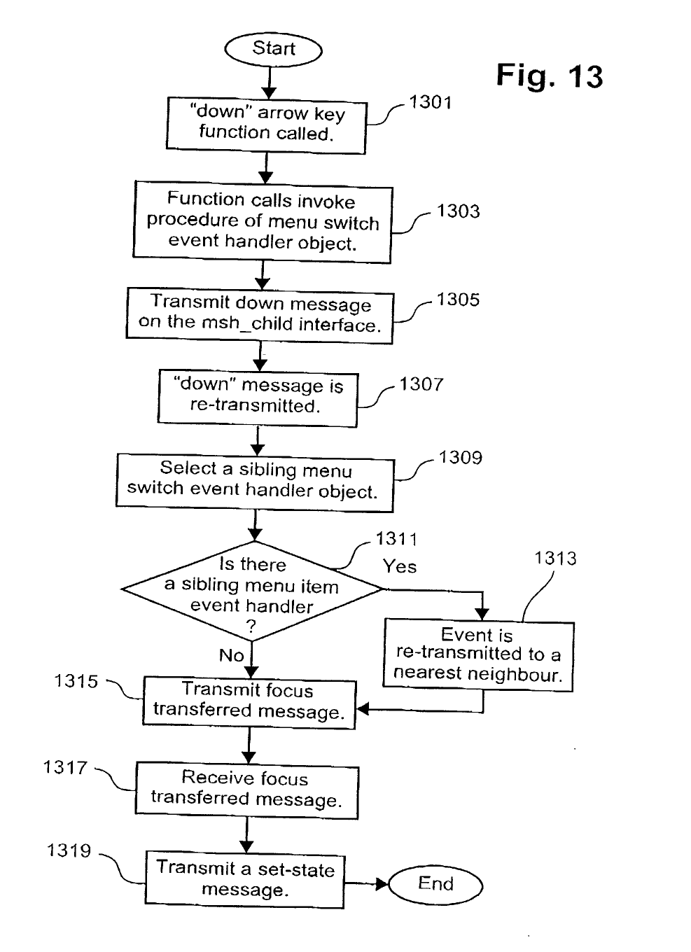

The screen 700 shows the item 701 as active. Each of the items 701 to 704 can be selected by a user utilising a mouse 603 or the keyboard 602 press in a conventional manner. The menu items 701 to 704 are configured as a “copy” button, an “edit” button, a “services” button and a “presets” button, respectively. In accordance with the example application program, the items 701 to 704 are configured to transfer focus to their nearest neighbour in a specified direction upon a focus request. For example, FIG. 13 is a flow chart showing the process 1300 performed when the user presses the down arrow key on the keyboard 602, if the screen 700 is being displayed. The process 1300 is preferably resident on the hard disk drive 610 of the computer system 600 and is read and controlled in its execution by the processor 605. The process 1300 begins at step 1301, where the user presses the down arrow key on the keyboard 602, and the host graphical user interface passes a message to the application program, which calls a function provided for the purpose of interpreting arguments resulting from keyboard presses. At the next step 1303, the function calls the “invoke” procedure of the top-level menu switch event handler object, passing an interface identifier “msh_raw_input”, a signal identifier “key_down”, and information which identifies the pressed key. At step 1305, a data field identifying the menu screen event handler object associated with the item 701 which currently has the focus is examined and a “down” message is transmitted on an “msh_child” interface to the menu screen event handler object which has the focus.

At the next step 1307, the menu screen event handler object associated with the item 701 receives the message on a “mh_parent” interface associated with the menu screen event handler object. The invoke procedure of the menu screen event handler object associated with the item 701 selects the menu item event handler object that currently has the focus and re-transmits the “down” message to the selected menu item event handler object on an “mh_child” interface. At the next step 1309, the selected menu item event handler object receives the message on an “mh_parent” interface associated with the selected menu item event handler object (ie. associated with the item 701) and the “invoke” procedure of the selected menu item event handler object selects a sibling menu item event handler object that is recorded as the focus recipient in the “down” direction from the menu item event handler object associated with the item 701. At the next step 1311, if there is a sibling menu item event handler object, then the process 1300 proceeds to step 1313. At step 1313, the menu item event handler object associated with the item 701, emits a “set_focus” message to the sibling menu item event handler object on an “fh_giver” interface. The sibling menu item event handler object receives the signal on an “fh_taker” interface associated with the sibling menu item event handler object, and the “invoke” procedure of the menu item event handler object associated with the item 701, re-transmits the event to a nearest neighbour in the direction specified by the argument resulting from the keyboard press (ie. down in this example), and the process 1300 continues at step 1315.

Otherwise, after step 1311 the process 1300 proceeds directly to step 1315, where the “invoke” procedure of the menu item event handler object associated with the item 701 transmits a “focus_transferred” message on an “mih_parent” interface associated with the menu item event handler object of the item 701. At the next step 1317, the menu screen event handler object associated with the item 701, receives the “focus_transferred” message on an “mh_child” interface associated with that menu screen event handler object.

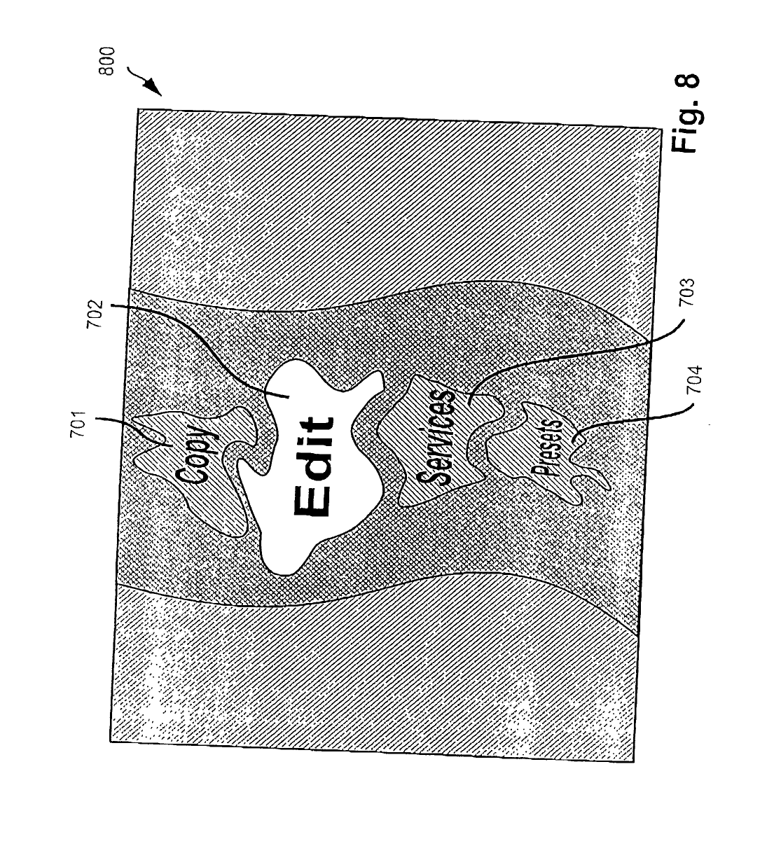

At the next step 1319, the invoke procedure of the menu screen event handler object associated with the item 701, emits a set-state message to all children menu screen event handler objects, passing an argument to indicate which state any associated graphical objects should change (ie. active or inactive). In the present example, the child menu item event handler object associated with the item 702 changes the state of any associated graphical objects, resulting in the screen 800 as shown in FIG. 8.

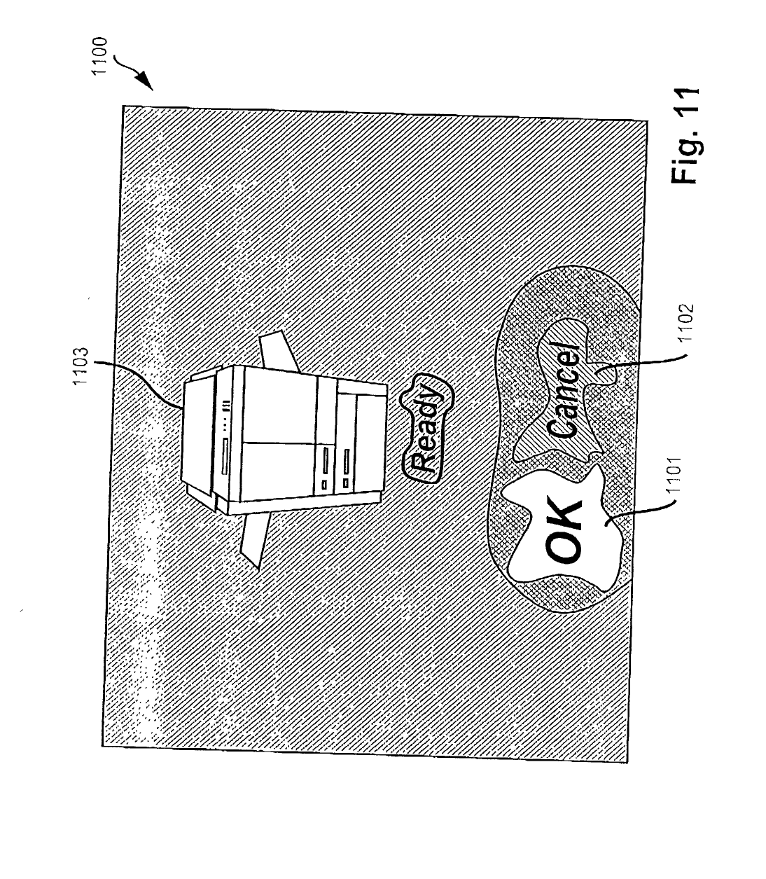

An action request on the item 701 results in the screen 1100 being displayed as shown in FIG. 11. The screen 1100 includes two associated menu items, “OK” 1101 and cancel 1102. An action request on the OK item 1101 causes an animation of a copier 1103, in the process of printing, to be displayed. An action request on the cancel item 1102 results in a change to the focus from the screen 1100 to whichever menu screen had the focus previously (ie. in accordance with this example, the screen 700).

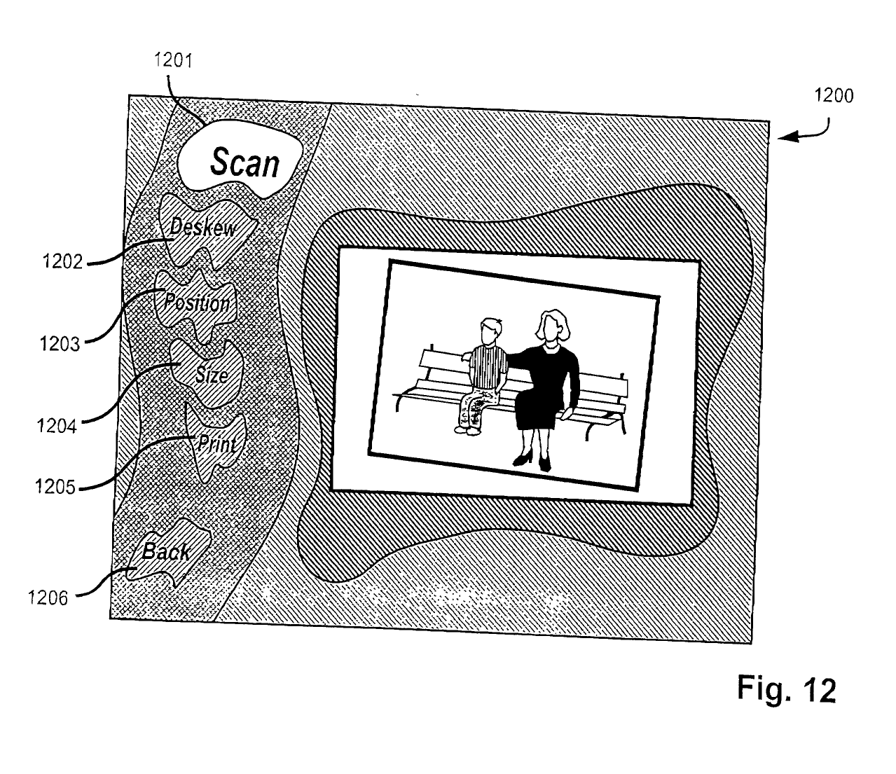

An action request on the item 702 results in the display of an edit screen 1200, as shown in FIG. 12, which has six menu items 1201 to 1206, of which two (ie. scan 1201 and Back 1206), are always visible. The remaining four menu items (ie. Deskew 1202; Position 1203, Size 1204 and Print 1205), only become visible once the scan item has been activated, as shown in FIG. 12. An edit screen event handler object associated with the edit screen 1200 is an instance of a subclass of menu screen event handler objects modified so that an image appears on the display screen when the scan item is activated.

An action request on the item 703 results in a services screen (not shown) being displayed on the display device 614. The services screen has a total of four menu items (ie. Order Toner; Order Paper, Call Technician, and Back). An action request on the call technician item results in a video of a person wearing a headset and talking to be displayed. An action request on the back item results in a change to the focused menu screen to whichever menu screen had the focus previously.

An action request on the item 704 results in a presets screen (not shown) being displayed on the display device 614. The presets screen has a total of five menu items (ie. Leave Form; Organisation Chart, Telephone List, and Back).

The methods described with reference to FIGS. 1 to 24 can be used to construct radio buttons, as known in the field of image processing, activated by mode events within an application program. In this instance, when such an application program receives input messages (eg. a message of the known types WM_MOUSEDOWN, WM_MOUSEUP, or WM_MOUSEMOVE), the application program attempts to call functions called mouse_down, mouse_up, and mouse_move respectively. Generally, two protocols are defined by a host graphical user interface system for distributing and responding to mouse events. These two protocols will hereinafter be referred to as “mouseraw” and “mousecooked” and are configured for processing raw and processed mouse events, respectively. The term raw mouse events refer to mouse events such as a click on a mouse button which results in a signal that is subsequently processed by an event handler object. A processed mouse event is a mouse event which has been forwarded to an event handler object after being processed by an intermediate event handler object. In the methods described herein, the “mouseraw” protocol preferably has two sides, identified as “parent” and “child” each having two sides identified as “sender” and “receiver”.

Four event handler objects for processing raw and processed mouse events associated with radio buttons, will be described below. These are referred to as a mouse distribution event handler objects, a mouse region event handler object, a radio button event handler object and a radio group event handler object.

The mouse distribution event handler object can be used to process mouse events. Such an event handler object preferably has an interface which uses the “parent” side of the mouseraw protocol and another interface which uses the “child” side of the mouseraw protocol. In the methods described herein, a mouse distribution event handler object receives notification of mouse events on the “child” interface and forwards the notification as a message to at least one event handler object associated with the “parent” interface of the mouse distribution event handler object. The mouse distribution event handler object can store information in order to performs ‘hit-testing’ in order to determine which of a number of associated event handler objects should receive the notified mouse event. Alternatively, the mouse distribution event handler object can send the notified mouse event to each event handler object associated with the sending mouse event handler object in turn, until one of the associated mouse distribution event handler objects accepts the mouse event.

The mouse region event handler object can be used to process raw mouse events. The mouse region event handler object preferably has an interface conforming to the “child” side of the “mouseraw” protocol and another interface conforming to the “sender” side of the “mousecooked” protocol. The mouse region event handler object receives “mouse_down”, “mouse_up”, and “mouse_move” messages, and in response to these messages can emit “pressed”, “clicked”, “released”, “entered”, and “exited” messages. An invoke procedure associated with the mouse region event handler object can be used to perform the processing necessary to emit the “pressed”, “clicked”, “released”, “entered”, and “exited” messages.

The radio button event handler object can be used to receive processed mouse events. The radio button event handler object preferably has an interface conforming to the “receiver” side of the “mousecooked” protocol to receive the processed mouse events. The radio button event handler object preferably has another interface which uses another protocol to emit “state_changed” messages and to receive “set_state” messages. When the radio button event handler object receives a “clicked” message on an interface, the radio button event handler object changes the state of any graphical objects associated with the radio button event handler object and emits a “state_changed” message on a “group member” interface.

The radio group event handler object can be used to receive “state_changed” messages and to emit “set_state” messages. Such an event handler object has an interface which uses one side of a protocol to receive “state_changed” messages and to emit “set_state” messages. When the radio group event handler object receives a “state_changed” messages, the radio group event handler object sends a “set_state” message to all other radio button event handler objects associated with the radio group event handler object, passing a set flag as an extra argument. When each of the radio button event handler objects receive the “set_state” signal, the receiving radio button event handler object examines the extra argument and, upon finding a set flag, changes the state of any graphical objects associated with the radio button event handler object to the up state.

In the methods described herein, the radio group event handler object and the radio button event handler object have no effect on the behaviour of any containing application associated with the event handler objects except for the effect on the state of any graphical objects associated with the event handler objects. Inheritance can also be used to create a subclass of radio group event handler objects, which may have additional interfaces, to result in other processes being performed.

In the methods described herein, the programmer views graphical objects as state machines with a finite number of states where the graphical objects can switch between states and initiate operations with respect to the core functionality of an application program. In contrast, the designer views graphical objects as being state machines with a finite number of states with animated transitions between the states. Therefore, the programmer need not concern themselves with the appearance of a graphical object, nor the designer with the implementation of the functionality that a graphical object possesses. Further, in the methods described herein, the designer can specify the appearance of state and transition by describing how states will look and how transitions will vary the appearance of the graphical object between states where the programmer on the other hand, needs to concern themselves only with the states, and how the function of objects differs as the state of the object is changed.

The methods described with reference FIGS. 1 to 24 may alternatively be implemented in dedicated hardware such as one or more integrated circuits performing the functions or sub functions of FIGS. 1 to 24. Such dedicated hardware may include graphic processors, digital signal processors, or one or more microprocessors and associated memories.

The procedures discussed above for the object classes included in the animated state machine will now be described in more detail below.

In the methods described herein, the animated state machine has the following associated procedures: ‘addstate’, ‘removestate’, ‘ismemberstate’, ‘getstates’, ‘setstate’, ‘getstate’, ‘addtrackdef’, ‘removetrackdef’, ‘ismembertrackdef’, ‘gettrackdefs’, ‘getquantum’, ‘calcroute’, ‘loop’, ‘update’, and ‘hasroute’.

The ‘addstate’ procedure takes a reference associated with self and a state object reference as input parameters. The ‘addstate’ procedure adds a corresponding state object to a table of state objects associated with the animated state machine.

The ‘removestate’ procedure takes a reference associated with self and a state object reference as input parameters. The ‘removestate’ procedure removes a corresponding state object from a table of state objects associated with the animated state machine.

The ‘ismemberstate’ procedure takes a reference associated with self and a state object reference as input parameters. The ‘ismemberstate’ procedure verifies that the corresponding state object is a member of a table of state objects associated with the animated state machine.

The ‘getstates’ procedure takes a reference associated with self as a sole input parameter. The ‘getstates’ procedure returns a set of state objects associated with the animated state machine.

The ‘setstate’ procedure takes a reference associated with self and a desired state object identifier as input parameters. The ‘setstate’ procedure sets the source state of the state machine to the state corresponding to the given state object identifier, provided that the given state object identifier is one of the members of the table of state objects associated with the animated state machine.

The ‘getstate’ procedure takes a reference associated with self and a desired state object identifier as input parameters. The ‘getstate’ procedure returns a reference associated with the currently active state object, which will be one of the members of the table of states objects associated with the animated state machine.

The ‘addtrackdef procedure’ takes a reference associated with self and a reference associated with a track definition object as input parameters. The ‘addtrackdef’ procedure adds the corresponding track definition object to a table of track definition objects associated with the animated state machine.

The ‘removetrackdef’ procedure takes a reference associated with self and a reference associated with a track definition object as input parameters. The ‘removetrackdef’ procedure removes the corresponding track definition object from the table of track definition objects associated with the animated state machine.

The ‘ismembertrackdef’ procedure takes a reference associated with self and a reference associated with a track definition object as input parameters. The ‘ismembertrackdef’ procedure verifies that the corresponding track definition object is a member of a table of track definition objects associated with the animated state machine.

The ‘gettrackdefs’ procedure takes a reference associated with self as a sole input parameter. The ‘getrackdefs’ procedure returns a set of track definition objects associated with the animated state machine.

The ‘getquantum’ procedure takes a reference associated with self as a sole input parameter. The ‘getquantum’ procedure returns a time quantum value.

In accordance with the methods described herein, state objects have the following associated procedures: ‘addkey’, ‘removekey’, ‘ismemberkey’, ‘getkey’, ‘getstatemachine’, ‘gettransition’, ‘gettransitions’, and ‘ApplyKeys’ procedures.

The ‘addkey’ procedure takes a reference associated with self and a reference associated with a key object as input parameters. The ‘addkey’ procedure adds a key object to a state object. If the state object already has a key object with the same track definition object, then the key object is replaced by the new key object. The key object will thereafter notify the state object if and when the key object changes.

The ‘removekey’ procedure takes a reference associated with self and a reference associated with a key object as input parameters. The ‘removekey’ procedure object removes a key object from a state object.

The ‘ismemberkey’ procedure takes a reference associated with self and a reference associated with a key object as input parameters. The ‘ismemberkey’ procedure returns whether or not a particular key object is a member of the state object.

The ‘getkey’ procedure takes a reference associated with self and a reference associated with a track definition object as input parameters. The ‘getkey’ procedure returns a reference associated with a key object from a state object when provided with the track definition object.

The ‘getstatemachine’ procedure takes a reference associated with self and a reference associated with a key object as input parameters. The ‘getstatemachine’ procedure returns the animated state machine for the key object.

The ‘gettransition’ procedure takes a reference associated with self and a reference associated with a key object as input parameters. The ‘gettransition’ procedure returns the transition between the state represented by the key object and the reference to state objects passed as an argument, and returns NULL if there is no link between the two states.

The ‘gettransitions’ procedure takes a reference associated with self and a reference associated with a key object as input parameters. The ‘gettransitions’ procedure adds a key object to a state object. If the state object already includes a key object with the same associated track definition object, then the key object is replaced by the new key object.

The transition class includes the following associated procedures: ‘addtrack’, ‘removetrack’, ‘ismembertrack’, ‘gettrack’, ‘getstatemachine’, ‘setduration’, ‘getduration’, ‘settostate’, ‘gettostate’, ‘setfromstate’, ‘getfromstate’, ‘setbidirectional’, ‘getbidirectional’, ‘settime’, ‘updatetrack’, and ‘updatealltracks’.

The ‘addtrack’ procedure is used to add a new element to an associated set of track objects associated with a particular transition object, provided that the track object has no associated key object with a time value greater than the transition duration of the associated track object. If the associated track definition object is already present in the transition object, then the associated track definition object will be left unchanged.

The track class has the following associated procedures: ‘addkey’, ‘removekey’, ‘ismemberkey’, ‘getkeys’, ‘gettrackdef’, and ‘getmaxtime’.

The ‘addkey’ procedure takes a reference associated with self and a reference associated with an associated key object as input parameters. The ‘addkey’ procedure is an abstract function that is provided by subclasses.

The ‘removekey’ procedure takes a reference associated with self and a reference associated with a key object as input parameters. The ‘removekey’ procedure is configured to remove a key object from a state object.

The ‘ismemberkey’ procedure takes a reference associated with self and a reference associated with a key object as input parameters. The ‘ismemberkey’ procedure returns an argument indicating whether or not a particular key object is a member of a table of key objects associated with the state object.

The ‘getkeys’ procedure takes a reference associated with self and a reference associated with a track definition object as input parameters. The ‘getkeys’ procedure returns a state key object from an associated state object when provided with the track definition object.

The ‘gettrackdef’ procedure takes a reference associated with self and a reference associated with a track definition object as input parameters. The ‘gettrackdef’ procedure returns a state key object from a state object when provided with the track definition object.

In the methods described herein, key objects have the following associated procedures: ‘gettime’, ‘settime’, ‘gettrackdef’, ‘trackdefchanged’, and ‘copy’.

The ‘gettime’ procedure takes a reference associated with self as a sole input parameter. The ‘gettime’ procedure returns the current time associated with a key object.

The ‘settime’ procedure takes a reference associated with self and a desired time as input parameters. The ‘settime’ procedure sets the current time associated with a key object to the state corresponding to a state identifier and notifies an associated track object, provided the key object is associated with a track object rather than a state object. The ‘settime’ procedure should not be called on a key object that is associated with a state object.

The ‘gettrackdef’ procedure takes a reference associated with self as a sole input parameter. The ‘gettrackdef’ procedure returns the track definition object associated with a key object.

The above-mentioned methods comprise a particular control flow. There are many other variants of the methods which use different control flows without departing the spirit or scope of the invention. Furthermore one or more of the steps of the preferred methods may be performed in parallel rather sequentially.

The foregoing describes only some arrangements of the present invention, and modifications and/or changes can be made thereto without departing from the scope and spirit of the invention, the arrangements being illustrative and not restrictive.

The claims defining the invention are as follows:

1. A method of rendering a graphical object on a graphical user interface, said graphical object having an associated animated state machine, said animated state machine comprising a plurality of states each of which corresponds to a mode of rendering said graphical object, each of said states having an associated state transition representing a transition of said graphical object between at least two of said states, said method comprising at least the step of:
executing at least one state transition between a first state of said graphical object and a second state, in order to render said graphical object according to attribute values defined for said graphical object at one or more corresponding times between said first state and said second state,
wherein in response to an event occurring in relation to said graphical user interface at any time prior to completion or said execution, said execution of said at least one state transition is altered in order to render said graphical object according to a third state.

2. A method according to claim 1, wherein execution of said at least one state transition is reversed in order to render said graphical object according to said third state.

3. A method according to claim 1, wherein upon altering said execution of said at least one state transition, one or more further state transitions are appended to said at least one state transition in order to render said graphical object according to said third state.

4. A method according to claim 3, wherein one or more intermediate states exist between said first state and said second state of said graphical object.

5. A method according to claim 4, wherein one or more further state transitions are appended to any one of said intermediate states in order to render said graphical object according to said third state.

6. A method according to claim 3, further comprising the steps of:
removing any unnecessary state transitions occurring between said first state and said second state; and
selecting one or more remaining state transitions to represent a route between said first state of said graphical object and said third state, wherein,
if at least one state of said route is equal to said first state, then the executing state transition is reversed and a first state transition of said route is removed from said route to produce an amended route which is utilised to render said graphical object, otherwise
said route is utilised to render said graphical object.

7. A method according to claim 6, wherein said at least one state of said route is a sequentially second state of said route.

8. A method according to claim 6, wherein said route represents a least number of said state transitions required to render said graphical object according to said third state.

9. An apparatus for rendering a graphical object on a graphical user interface, said graphical object having an associated animated state machine, said animated state machine comprising a plurality of states each of which corresponds to a mode of rendering said graphical object, each of said states having an associated state transition representing a transition of said graphical object between at least two of said states, said apparatus comprising:
execution means for executing at least one state transition between a first state of said graphical object and a second state, in order to render said graphical object according to attribute values defined for said graphical object at one or more corresponding times between said first state and said second state,
wherein in response to an event occurring in relation to said graphical user interface at any time prior to completion of said execution, said execution of said at least one state transition is altered in order to render said graphical object according to a third state.

10. A program including computer-implemented program codes, said program being configured for rendering a graphical object on a graphical user interface, said graphical object having an associated animated state machine, said animated state machine comprising a plurality of states each of which corresponds to a mode of rendering said graphical object, each of said states having an associated state transition representing a transition of said graphical object between at least two of said states, said program comprising:
code for executing at least one state transition between a first state of said graphical object and a second state, in order to render said graphical object according to attribute values defined for said graphical object at one or more corresponding times between said first state and said second state,
wherein in response to an event occurring in relation to said graphical user interface at any time prior to completion of said execution, said execution of said at least one state transition is altered in order to render said graphical object according to a third state.

11. A graphical user interface comprising one or more graphical objects, each of said graphical objects having one or more associated states, each of said states representing a mode of rendering a corresponding graphical object, said graphical user interface being characterised in that transitioning between a plurality of states associated with at least one of said graphical objects is executed by an animated state machine.

12. A graphical user interface according to claim 11, wherein in response to an event occurring in relation to said graphical user interface at any time prior to completion of at least one transition between a first and a second of said plurality of states, said at least one transition is altered in order to render said graphical object according to a third state.

13. A graphical user interface according to claim 12, wherein execution of said at least one state transition is reversed in order to render said graphical object according to said third state.

14. A graphical user interface according to claim 13, wherein upon altering said execution of said at least one state transition, one or more further state transitions are appended to said at least one state transition to render said graphical object according to said third state.

15. A graphical user interface according to claim 14, wherein one or more intermediate states exist between said first state and said second state of said graphical object.

16. A graphical user interface according to claim 15, wherein one or more further state transitions are appended to any one of said intermediate states in order to render said graphical object according to said third state.

17. A graphical user interface according to claim 14, further comprising:
removal means for removing any unnecessary state transitions occurring between said first state and said second state; and
selecting one or more remaining state transitions to represent a route between said first state of said graphical object and said third state, wherein,
if at least one state of said route is equal to said first state, then the executing state transition is reversed and a first state transition of said route is removed from said route to produce an amended route which is utilised to render said graphical object, otherwise
said route is utilised to render said graphical object.

18. A graphical user interface according to claim 17, wherein said at least one state of said route is a sequentially second state of said route.

19. A graphical user interface according to claim 17, wherein said route represents a least number of said state transitions required to render said graphical object according to said third state.

20. A method of updating a route currently being executed by an animated state machine, said animated state machine being associated with a graphical object and comprising a plurality of states each of which corresponds to a mode of rendering said graphical object, each of said states having an associated state transition representing a transition of said graphical object between at least two of said states, wherein said route comprises a first sequential plurality of said state transitions, said method comprising the steps of:
removing any unnecessary state transitions from said currently executing route; and
selecting a second sequential plurality of remaining state transitions to represent a new route between a first state of said graphical object and a second state, wherein,
if at least one state of said now route is equal to a first state of a currently executing transition of said currently executing route, then said currently executing transition is reversed and a first transition of said new route is removed from said new route to produce an amended new route which is utilised to update said currently executing route, otherwise
said new route is utilised to update said currently executing route.

21. A method according to claim 20, wherein said new route represents a least number of said state transitions required to render said graphical object according to said second state.

22. A method according to claim 20, wherein said at least one state of said new route is a sequentially second state of said new route.

23. A method according to claim 20, wherein said method is performed in response to a user input event associated with said graphical object.

24. A method according to claim 20, wherein said new route includes at least one intermediate state.

25. A method of updating a route currently being executed by an animated state machine, said animated state machine being associated with a graphical object and comprising a plurality of states each of which corresponds to a mode of rendering said graphical object, each of said states having an associated state transition representing a transition of said graphical object between said states, wherein said route comprises a first sequential plurality of said state transitions, said method comprising the steps of:
removing any unnecessary state transitions from said currently executing route;
selecting a sequential plurality of any remaining state transitions to represent a new route between a first state of said graphical object and a second state;
updating said currently executing route utilising said new route.

26. A method according to claim 25, wherein if at least one state of said new route is equal to a first state of a currently executing transition of said currently executing route, then said currently executing transition is reversed and a first transition of said new route is removed from said new route to produce all amended new route which is utilised to update said currently executing route, otherwise said new route is utilised to update said currently executing route.

27. A method according to claim 25, wherein said at least one state of said new route is a sequentially second state of said new route.

28. A method according to claim 25, wherein said new route represents a least number of said state transitions required to render said graphical object according to said second state.

29. A method according to claim 25, wherein at least one intermediate state is defined between said first state of said graphical object and said second state.

30. A method according to claim 25, wherein said method is performed in response to a user input event associated with said graphical object.

31. A method of updating an animated state machine in response to a user event, said animated state machine being associated with a graphical object, said method comprising the steps of:
deleting any unnecessary transitions from a currently executing route of said animated state machine upon detection of said user event; and
selecting a sequential plurality of any remaining state transitions to form a new route representing a least number of state transitions required to render said graphical object according to a current state and a destination state,
wherein if a second state of said new route is equal to a first state of a currently executing transition of said currently executing route, then said currently executing transition is reversed and a first transition of said new route is removed from said new route to produce an amended new route which is utilised to update said currently executing route, otherwise
said new route is utilised to update said currently executing route.

32. An apparatus for updating a route currently being executed by an animated state machine, said animated state machine being associated with a graphical object and comprising a plurality of states each of which corresponds to a mode of rendering said graphical object, each of said states having an associated state transition representing a transition of said graphical object between at least two of said states, wherein said route comprises a first sequential plurality of said state transitions, said apparatus comprising:
removal means for removing any unnecessary state transitions from said currently executing route; and
selection, means for selecting a second sequential plurality of remaining state transitions to represent a new route between a first state of said graphical object and a second state, wherein,
if at least one state of said new route is equal to a first state of a currently executing transition of said currently executing route, then said currently executing transition is reversed and a first transition of said new route is removed from said new route to produce an amended new route which is utilised to update said currently executing route, otherwise
said new route is utilised to update said currently executing route.

33. An apparatus for updating a route currently being executed by an animated state machine, said animated state machine being associated with a graphical object and comprising a plurality of states each of which corresponds to a mode of rendering said graphical object, each of said states having an associated state transition representing a transition of said graphical object between said states, wherein said route comprises a first sequential plurality of said state transitions, said apparatus comprises:
removal means for removing any unnecessary state transitions from said currently executing route;
selection means for selecting a sequential plurality of any remaining state transitions to represent a new route between a first state of said graphical object and a second state;
update means for updating said currently executing route utilising said new route.

34. An apparatus for updating an animated state machine in response to a user event, said animated state machine being associated with a graphical object, said apparatus comprising:
deletion means for deleting any unnecessary transitions from a currently executing route of said animated state machine upon detection of said user event; and
selection means for selecting a sequential plurality of any remaining state transitions to form a new route representing a least number of state transitions required to render said graphical object according to a current state and a destination state,
wherein if a second state of said new route is equal to a first state of a currently executing transition of said currently executing route, then said currently executing transition is reversed and a first transition of said new route is removed from said new route to produce an amended new route which is utilised to update said currently executing route, otherwise
said new route is utilised to update said currently executing route.

35. A program stored in a memory medium of an apparatus, said program being configured to update a route currently being executed by an animated state machine, said animated state machine being associated with a graphical object and comprising a plurality of states each of which corresponds to a mode of rendering said graphical object, each of said states having an associated state transition representing a transition of said graphical object between at least two of said states, wherein said route comprises a first sequential plurality of said state transitions, said program comprising:
code for removing any unnecessary state transitions from said currently executing route; and
code for selecting a second sequential plurality of remaining state transitions to represent a new route between a first state of said graphical object and a second state, wherein,
if at least one state of said new route is equal to a first state of a currently executing transition of said currently executing route, then said currently executing transition is reversed and a first transition of said new route is removed from said new route to produce an amended new route which is utilised to update said currently executing route, otherwise
said new route is utilised to update said currently executing route.

36. A program according to claim 35, wherein said new route represents a least number of said state transitions required to render said graphical object according to said second state.

37. A program according to claim 35, wherein said at least one state of said new route is a sequentially second state of said new route.

38. A program according to claim 35, wherein said new route includes at least one intermediate state.

39. A program stored in a memory medium of an apparatus, said program being configured to update a route currently being executed by an animated state machine, said animated state machine being associated with a graphical object and comprising a plurality of states each of which corresponds to a mode of rendering said graphical object, each of said states having an associated state transition representing a transition of said graphical object between said states, wherein said route comprises a first sequential plurality of said state transitions, said program comprising:
code for removing any unnecessary state transitions from said currently executing route;
code for selecting a sequential plurality of any remaining state transitions to represent a new route between a first state of said graphical object and a second state;
code for updating said currently executing route utilising said new route.

40. A program according to claim 39, wherein if at least one state of said new route is equal to a first state of a currently executing transition of said currently executing route, then said currently executing transition is reversed and a first transition of said new route is removed from said new route to produce an amended new route which is utilised to update said currently executing route, otherwise said new route is utilised to update said currently executing route.

41. A program according to claim 40, wherein said at least one state of said new route is a sequentially second state of said new route.

42. A program according to claim 39, wherein said new route represents a least number of said state transitions required to render said graphical object according to said destination state.

43. A program according to claim 39, wherein at least one intermediate state is defined between said first state of said graphical object and said second state.

44. A program including computer-implemented program codes, said program being configured to update an animated state machine in response to a user event, said animated state machine being associated with a graphical object, said program comprising:
code for deleting any unnecessary transitions from a currently executing route of said animated state machine upon detection of said user event; and
code for selecting a sequential plurality of any remaining state transitions to form a new route representing a least number of state transitions required to render said graphical object according to a current state and a destination state,
wherein if a second state of said new route is equal to a first state of a currently executing transition of said currently executing route, then said currently executing transition is reversed and a first transition of said new route is removed from said new route to produce an amended new route which is utilised to update said currently executing route, otherwise
said new route is utilised to update said currently executing route.

45. A method of updating a route currently being executed by an animated state machine, said animated state machine being associated with a graphical object and comprising a plurality of states each of which corresponds to a mode of rendering said graphical object, each of said states having an associated state transition representing a transition of said graphical object between at least two of said states, wherein said route comprises a first sequential plurality of said state transitions, said method comprising the steps of:
removing any previously executed state transitions from said currently executing route of said animated state machine; and
selecting a second sequential plurality of remaining state transitions to represent a new route between a current state of said graphical object and a destination state, said new route including at least one intermediate state wherein,
if a second state of said new route is equal to a first state of a currently executing transition of said currently executing route, then said currently executing transition is reversed and a first transition of said new route is removed from said new route to produce an amended new route which is utilised to update said currently executing route, otherwise
said new route is utilised to update said currently executing route.

46. The method according to claim 45, wherein said new route represents a least number of said state transitions required to render said graphical object according to said destination state.

47. An apparatus for updating a route currently being executed by an animated state machine, said animated state machine being associated with a graphical object and comprising a plurality of states each of which corresponds to a mode of rendering said graphical object, each of said states having an associated state transition representing a transition of said graphical object between at least two of said states, wherein said route comprises a first sequential plurality of said state transitions, said apparatus comprising:
removal means for removing any previously executed state transitions from said currently executing route of said animated state machine; and
selection means for selecting a second sequential plurality of remaining state transitions to represent a new route between a current state of said graphical object and a destination state, said new route including at least one intermediate state wherein,
if a second state of said new route is equal to a first state of a currently executing transition of said currently executing route, then said currently executing transition is reversed and a first transition of said new route is removed from said new route to produce an amended new route which is utilised to update said currently executing route, otherwise
said new route is utilised to update said currently executing route.

48. A program including computer-implemented program codes, said program being configured to update a route currently being executed by an animated state machine, said animated state machine being associated with a graphical object and comprising a plurality of states each of which corresponds to a mode of rendering said graphical object, each of said states having an associated state transition representing a transition of said graphical object between at least two of said states, wherein said route comprises a first sequential plurality of said state transitions, said program comprising:
code for removing any previously executed state transitions from said currently executing route of said animated state machine; and
code for selecting a second sequential plurality of remaining state transitions to represent a new route between a current state of said graphical object and a destination state, said new route including at least one intermediate state wherein,
if a second state of said new route is equal to a first state of a currently executing transition of said currently executing route, then said currently executing transition is reversed and a first transition of said new route is removed from said new route to produce an amended new route which is utilised to update said currently executing route, otherwise
said new route is utilised to update said currently executing route.

49. A program according to claim 48, wherein said new route represents a least number of said state transitions required to render said graphical object according to said destination state.
